(19) United States
(12) Patent Application Publication
(10) Pub. No.: US 2018/0143956 A1
(43) Pub. Date: May 24, 2018

(54) REAL-TIME CAPTION CORRECTION BY AUDIENCE

(71) Applicant: Microsoft Technology Licensing, LLC, Redmond, WA (US)

(72) Inventors: Evgeny Skarbovsky, Sammamish, WA (US); Frank Tompkins Spokane, Washington, DC (US); Gregory Paul Baribault, Sammamish, WA (US)

(73) Assignee: Microsoft Technology Licensing, LLC, Redmond, WA (US)

(21) Appl. No.: 15/382,540

(22) Filed: Dec. 16, 2016

Related U.S. Application Data
(60) Provisional application No. 62/424,266, filed on Nov. 18, 2016.

(51) Int. Cl. G06F 17/24; G10L 15/26; G10L 15/01

(52) U.S. Cl. CPC G06F 17/24; G10L 2015/025; G10L 15/01; G10L 15/265

(57) ABSTRACT

The generation and presentation of text based on an audiovisual content item are improved by providing audience members with interface tools to quickly and intuitively modify text items in real-time as the audience consumes the audiovisual content item. The audience members' selections are provided to an aggregation engine as the audience consumes the content item and influences future selections for transcribing content items and future transmission of the transcript to the audience. The editor interface provides the n-best suggestions to replace a given word or words in the text and to add richness to the text for improved functionality in receiving accurate and readable text conversions from audiovisual content items. The aggregation engine harnesses the crowd knowledge provided by the audience devices and directs its impact to reduce the effect of intentional or accidental bad actors on the transcript.

### RELATED APPLICATIONS

This application claims priority from U.S. Provisional Patent Application No. 62/424,266 titled, “REAL-TIME CAPTION CORRECTION BY AUDIENCE” and having a filing date of Nov. 18, 2016, which is incorporated herein by reference.

### BACKGROUND

A meeting, webinar, or other online or broadcast event may be transcribed to text and presented as captions to an audience. The transcription that results may be made available for download following the event. When the text captions are machine generated, as through a speech-to-text engine, mistakes are inevitable. Such mistakes make understanding the text more difficult, and distract from the viewing experience.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

Systems and methods for real-time caption correction provide for a member of an audience to view speech-to-text generated captions and correct the captions in real-time prior as the captions are delivered in concert with audiovisual data. Participating audience members are provided the real-time captions, and words or phrases in the real-time captions may be associated with a confidence score that has been generated by the text-to-speech engine. If a confidence score falls below a certain threshold value, for example 80 on a zero to 100 scale, the associated word may have its format changed. For example, the word may be presented in a different color or may be highlighted, bolded, italicized, or placed in all capital letters. In addition, words may be associated with a list of potential alternative words that may be used. Each alternative word is associated with a confidence score and may be presented in order of score, for example, from highest to lowest.

Should the audience member spot an incorrect word in the text-to-speech caption, several alternative options are available. The audience member may type in the corrected word or may select from one of the words in the list. In addition to correcting wrong words in the transcript, the audience member may delete stray words that appear that have not actually been spoken; insert words that were missed by the text-to-speech engine; or may fix punctuation in the transcript. In addition, the method and system described provide for correction of the transcript, so that the transcript accessed after the event may optionally include the corrections. Edits made by audience members may be corrected on their personal devices to affect their individual views of the transcript, but are also collected by a transcript database to determine whether to affect a shared transcript or a contextual dictionary used to transcribe the event. Various machine learning and artificial intelligence systems are used to determine whether audience-made edits should be incorporated into the shared transcript for the event. Thus, what is described fixes the speech-to-text captions in real-time, for Video-on-Demand viewing later, and for any final transcripts.

Through implementation of this disclosure, the functionalities of the computing devices that are employed in captioning are improved. For example, the speech-to-text algorithm may be improved and made more efficient through the feedback that the algorithm receives via the corrections received from the audience. Furthermore, the output of the system is far more accurate as a result of the input from the audience.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example operating environment in which real-time caption correction may be practiced by an audience;

FIGS. 2A-I illustrate example display interfaces;

FIGS. 3A-E illustrate example replacement interfaces;

FIGS. 4A and 4B illustrate example display interfaces, in which a custom entry control of a replacement interface has been selected;

FIG. 5 is a flow chart showing general stages involved in an example method for real-time caption correction by an audience;

FIG. 6 is a flow chart showing general stages involved in an example method for handling audience-suggested corrections to captions;

FIG. 7 is a block diagram illustrating example physical components of a computing device;

FIGS. 8A and 8B are block diagrams of a mobile computing device; and

FIG. 9 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

Systems and methods for real-time caption correction provide for a member of an audience to view speech-to-text generated captions and correct the captions in real-time prior as the captions are delivered in concert with audiovisual data. Participating audience members are provided the real-time captions, and words or phrases in the real-time captions may be associated with a confidence score that has been generated by the text-to-speech engine. If a confidence score falls below a certain threshold value, for example 80 on a zero to 100 scale, the associated word may have its format changed. For example, the word may be presented in a different color or may be highlighted, bolded, italicized, or placed in all capital letters. In addition, words may be associated with a list of potential alternative words that may be used. Each alternative word is associated with a confidence score and may be presented in order of score, for example, from highest to lowest.

Should the audience member spot an incorrect word in the text-to-speech caption, several alternative options are available. The audience member may type in the corrected word or may select from one of the words in the list. In addition to correcting wrong words in the transcript, the audience member may delete stray words that appear that have not actually been spoken; insert words that were missed by the text-to-speech engine; or may fix punctuation in the transcript. In addition, the method and system described provide for correction of the transcript, so that the transcript accessed after the event may optionally include the corrections. Edits made by audience members may be corrected on their personal devices to affect their individual views of the transcript, but are also collected by a transcript database to determine whether to affect a shared transcript or a contextual dictionary used to transcribe the event. Various machine learning and artificial intelligence systems are used to determine whether audience-made edits should be incorporated into the shared transcript for the event. Thus, what is described fixes the speech-to-text captions in real-time, for Video-on-Demand viewing later, and for any final transcripts.

Through implementation of this disclosure, the functionalities of the computing devices that are employed in captioning are improved. For example, the speech-to-text algorithm may be improved and made more efficient through the feedback that the algorithm receives via the corrections received from the audience. Furthermore, the output of the system is far more accurate as a result of the input from the audience.

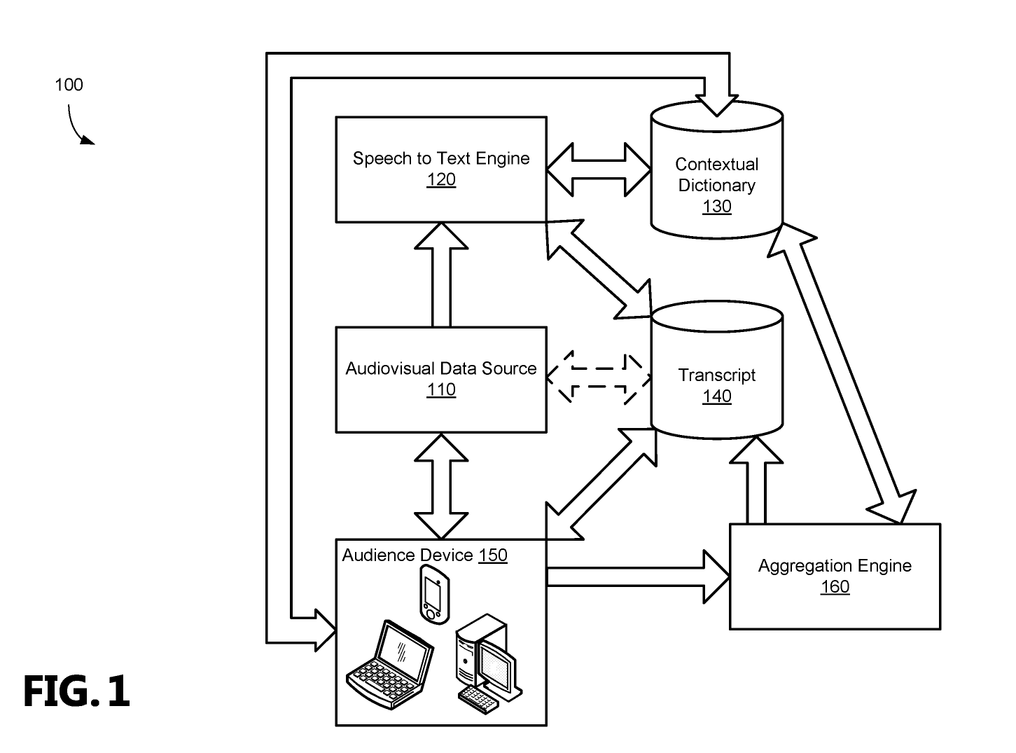

FIG. 1 illustrates an example operating environment 100 in which real-time caption correction may be practiced by an audience. As illustrated, an audiovisual data source communicates audiovisual data to a speech to text engine 120 and to audience devices 150. The speech to text engine 120 coverts speech data in the audiovisual data into text with the aid of a contextual dictionary 130, defining various words into which phonemes are to be translated, and stores the text of those words in a transcript database 140. The transcript database 140 provides the text as captioning data for consumption by the audience devices 150 in association with the audiovisual data. One or more of the audience devices 150 are configured to interact with the transcript to correct the captioning choices made by the speech to text engine 120. An aggregation engine 160 receives the corrections from the audience devices 150 and determines whether to update the text stored in the transcript database 140 and personalize the contextual dictionary 130 so that the corrected text items are incorporated into future choices made by the speech to text engine 120 for the given audiovisual content item.

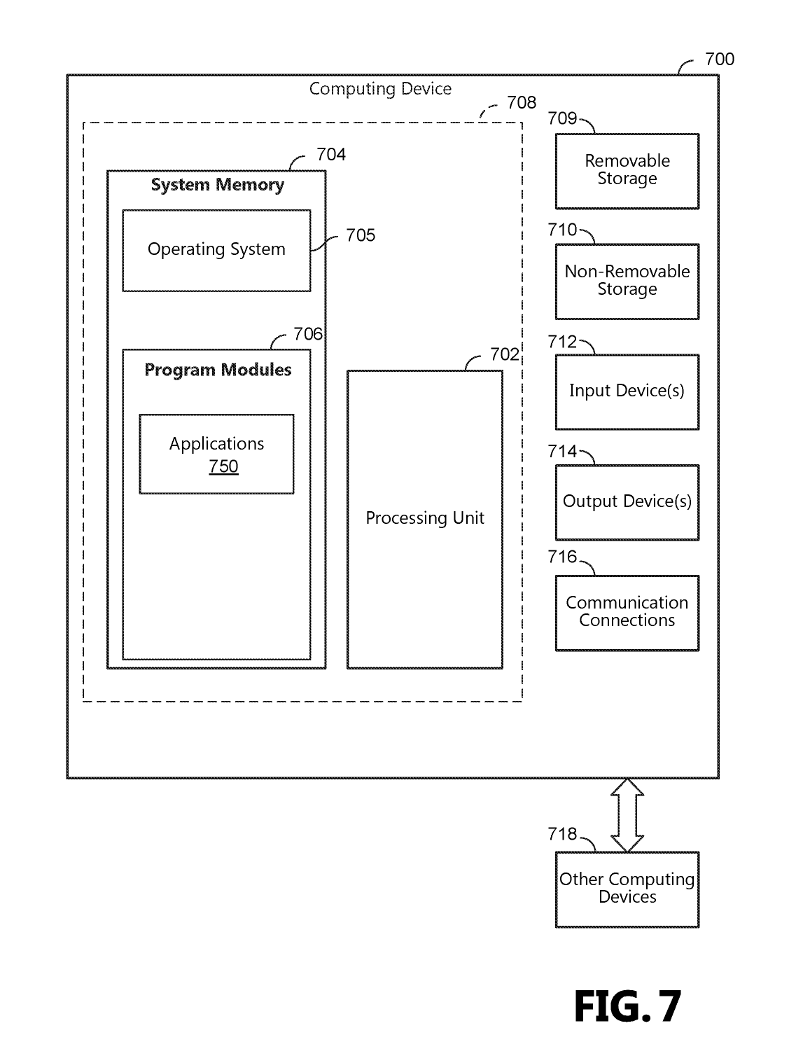

The audiovisual data source 110, speech to text engine 120, contextual dictionary 130, transcript database 140, audience devices 150, and aggregation engine 160 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 7-9.

While audiovisual data source 110, speech to text engine 120, contextual dictionary 130, transcript database 140, audience devices 150, and aggregation engine 160 are shown remotely from one another for illustrative purposes, it should be noted that several configurations of one or more of these devices hosted locally to another illustrated device are possible, and each illustrated device may represent multiple instances of that device (e.g., the audience device 150 represents all of the devices used by the audience of the audiovisual data). Various servers and intermediaries familiar to those of ordinary skill in the art may lie between the component systems illustrated in FIG. 1 to route the communications between those systems, which are not illustrated so as not to distract from the novel aspects of the present disclosure.

The audiovisual data source 110 is the source for audiovisual data, which includes audiovisual data that is “live” or pre-recorded and broadcast to several audience devices 150 or unicast to a single audience device 150. In several aspects, “live” broadcasts include a transmission delay. For example, an event that is filmed “live” is accompanied by a delay of n seconds before being transmitted from the audiovisual data source 110 to audience devices 150 to allow for image and sound processing, censorship, the insertion of commercials, etc. The audiovisual data source 110 in various aspects includes content recorders (e.g., cameras, microphones), content formatters, and content transmitters (e.g., antennas, multiplexers). In various aspects, the audiovisual data source 110 is also an audience device 150, such as, for example, when two users are connected on a teleconference by their devices, each device is an audiovisual data source 110 and an audience device 150.

Audiovisual data provided by the audiovisual data source 110 include data formatted as fixed files as well as streaming formats that include one or more sound tracks (e.g., Secondary Audio Programming (SAP)) and optionally include video tracks. The data may be split across several channels (e.g., left audio, right audio, video layers) depending on the format used to transmit the audiovisual data. In various aspects, the audiovisual data source 110 includes, but is not limited to: terrestrial, cable, and satellite television stations and on-demand program providers; terrestrial, satellite, and Internet radio stations; Internet video services, such as, for example, YOUTUBE® or VIMEO® (respectively offered by Alphabet, Inc. of Mountain View, Calif. and InterActiveCorp of New York, N.Y.); Voice Over Internet Protocol (VOIP) and teleconferencing applications, such as, for example, WEBEX® or GOTOMEETING® (respectively offered by Cisco Systems, Inc. of San Jose, Calif. and Citrix Systems, Inc. of Fort Lauderdale, Fla.); and audio/video storage sources networked or stored locally to an audience device 150 (e.g., a “my videos” folder).

The speech to text engine 120 is an automated system that receives audiovisual data and creates text, timed to the audio portion of the audiovisual data to create a transcript that may be played back in association with the audiovisual data as captions. In various aspects, the speech to text engine 120 provides data processing services based on heuristic models and artificial intelligence (e.g., machine or reinforcement learning algorithms) to extract speech from other audio data in the audiovisual data. For example, when two persons are talking over background noise (e.g., traffic, a song playing in the background, ambient noise), the speech to text engine 120 is operable to provide conversion for the speech, but not the background noises, by using various frequency filters, noise level filters, or channel filters on the audio data to isolate the speech data.

The contextual dictionary 130 provides a list of words and the phonemes from which those words are comprised to the speech to text engine 120 to match to the speech data of the audiovisual data. Suggested replacements for selected text items are also provided by the contextual dictionary 130 to audience devices 150 that are actively suggesting edits. Although examples are given herein primarily in the English language, speech to text engines 120 and contextual dictionaries 130 are provided in various aspects for other languages, and a user may specify one or more languages to use in creating the transcript by specifying an associated speech to text engines 120 and contextual dictionary 130. Non-English language examples given herein will be presented using Latin text and translations (where appropriate) will be identified with guillemets (i.e., the symbols “«” and “»”). Phonemes may also be discussed in symbols associated with the International Phonetic Alphabet (IPA) for English, which will be identified with square brackets (i.e., the symbols “[” and “]”) around the examples in the present disclosure to distinguish IPA examples from standard written English examples.

For words with identical or similar phonemes, such as homophones, the contextual dictionary 130 will provide multiple potential words that the speech to text engine 120 is operable to select from, based on syntax and context of the data it is translating. The speech to text engine 120 will select the entry for which it has the highest confidence in matching the identified phonemes from the contextual dictionary 130 to provide in the transcript. The speech to text engine 120 is further configured to provide the next n-best alternatives to the best entry as suggested replacements to users; those entries with the next-most highest confidences as matching the phonemes.

The contextual dictionary 130 is augmented from a base state (e.g., a standard dictionary, a prior-created contextual dictionary 130) to include terminology discovered via context mining from the event to be transcribed. For example, a meeting event may be mined to discover its attendees, a title and description, and documents attached to that meeting event. These data are parsed to derive contextual information about the event, and are used as a starting point to mine for additional data according to a relational graph in communication with one or more databases and files repositories. Continuing the example, the names of the attendees and terms parsed from the title description and attached documents are added to the contextual dictionary 130, and are used to discover additional, supplemental contextual information for inclusion in the contextual dictionary 130. In some aspects, a user interface is provided to alert a user to the terminology affected in the contextual dictionary 130 by the discovered contextual information and supplemental information, as well as to manually personalize terminology in the contextual dictionary 130 by adding terms or influencing weightings of those terms in the contextual dictionary 130.

In various aspects, various weightings or personalizations are made to the dictionary 130 as feedback is received on the textual data provided in the transcript so that the choices made by the speech to text engine 120 are influenced by the feedback. For example, if the speakers in the audio data speak with an accent, the speech to text engine 120 may select incorrect words from the contextual dictionary 130 based on the unfamiliar phonemes used to pronounce the accented word. As pronunciation feedback is received to select corrected text, the word associated with the corrected text will have its confidence score in the contextual dictionary 130 increased so that the given word will be provided to the speech to text engine 120 (even if it were not before) when the phonemes are encountered again. In various aspects, pronunciation feedback specifies one of a selection of accents known for a given language or characteristics of an accent (e.g., elongated/shortened vowels, rhotic/non-rhotic, t-glottalization, flapping, consonant switches, vowel switches).

Confidence scores for a word (or words) for a given set of phonemes are influenced by an exactness of the recognized phonemes from the speech data matching stored phonemes associated with the word in the contextual dictionary 130, but also include personalization for pronunciation feedback, corrections to the transcript, and frequency of use for given words in a given language (i.e., how commonly a given word is expected to be used). For example, the words “the” and “thee” share the same phonemes in certain situations (i.e., a person may pronounce the two words identically as [ði]), but the contextual dictionary 130 will associate a higher confidence score with “the” as it is used more frequently in modern English speech than “thee”. However, if the speaker is noted in feedback as using archaic English speech (e.g., in a reenactment or a period drama set in a time using archaic speech, quoting from an archaic document) or the word “the” is corrected to “thee” by one or more audience devices 150, the contextual dictionary 130 is personalized to the audiovisual content item to provide a greater relative confidence score to the word “thee” compared to “the” when converting the audiovisual content item's speech data into textual data. The contextual dictionary 130 may be applied to a single audiovisual content item or specified to be used for a subsequent audiovisual content item (e.g., the next episode in a series, a subsequent lecture) instead of an unpersonalized dictionary. In various aspects, the speech to text engine 120 is configured to use the confidence scores provided by the contextual dictionary 130 along with its own scoring system, which may take into account syntax and grammar, to produce confidence scores for phoneme to word matching that account for other identified words.

In various aspects, the contextual dictionary 130 is provided with contextual information related to the event being transcribed and its participants from various databases. The contextual information provide names and terms to expand the vocabulary available from the contextual dictionary 130, and are used to provide supplemental contextual information, to further augment the contextual dictionary 130, from a graph database that is automatically mined for supplemental contextual information based on the contextual information of the event.

A graph database provides one or more relational graphs with nodes describing entities and a set of accompanying properties of those entities, such as, for example, the names, titles, ages, addresses, etc. Each property can be considered a key/value pair—a name of the property and its value. In other examples, entities represented as nodes include documents, meetings, communication, etc., as well as edges representing relations among these entities, such as, for example, an edge between a person node and a document node representing that person's authorship, modification, or viewing of the associated document. Two persons who have interacted with the same document, as in the above example, will be connected by one “hop” via that document with the other person, as each person's node shares an edge with the document's node. The graph database executes graph queries that are submitted by various users to return nodes or edges that satisfy various conditions (e.g., users within the same division of a company, the last X documents accessed by a given user).

Contextual information are parsed from the event to be transcribed, and unique vocabulary words may be added to the contextual dictionary 130 in addition to strengthening or weakening the confidence scores for existing words in the contextual dictionary 130 for selection based on syntax and phoneme matching.

In one example, where the event to be transcribed is a webinar, a presentation deck, a meeting handout document, a presenter list, and an attendee list associated with the webinar are parsed to identify words and names for contextual information. The contextual dictionary 130 is then adjusted so that names of presenters/attendees will be given greater consideration by the speech to text engine 120 when transcribing the speech data. For example, when an attendee has the name “Smith” recognized from the contextual information, when the speech to text engine 120 identifies phonemes corresponding to [smIθ], “Smith” will be selected with greater confidence relative to “smith”. Similarly, other variants or partial matches to [smIθ] (e.g., “Smyth”, “smithereens”, “smit”) are deprecated so that the relative confidence of “Smith” to match the phonemes for [smIθ] is increased.

In another example, where the event to be transcribed is a previously recorded portion of a meeting, a broadcast title and metadata (e.g., review, synopsis, source) are used to identify contextual information, such as, for example, character names, vocabulary lists, etc., which may be located on an internet database or program guide. For example, for an event of playback of a speech from a science fiction convention to be transcribed, a character named “Lor” is identified as contextual data for the event so that the speech to text engine 120 will have greater relative confidence in selecting “Lor” over “lore” when phonemes corresponding to [l [symbol] r] are identified in the speech data. Similarly, when the event specific term of “Berelian”—noted as having a pronunciation of [bεrεlian]—is identified as contextual data for the event, phonemes corresponding to [bεrεlian] will be associated with the term “Berelian” when identified in the speech data for conversion to text. In various aspects, phoneme correspondence to a textual term for contextual data is determined based on orthographical rules of construction and spelling or a pronunciation guide.

The contextual information is used to discover supplemental contextual information in the graph database according to one or more graph queries. The graph queries specify numbers, types, and strength of edges between nodes representing the entities discovered in the contextual information and nodes representing entities to use as supplemental contextual information. For example, when the name of an attendee is discovered as contextual information for the event to be transcribed (e.g., in an attendee list, as metadata or content in a document associated with the event), the node associated with that attendee in the graph database is used as a starting point for a graph query. The nodes spanned according to the graph query, such as, for example, other persons, other events, and other documents interacted with by the attendee (a first “hop” in the graph database) or discovered as having been interacted with by entities discovered after the first hop (a subsequent “hop” spanning outward from an earlier “hop” in the graph database) to discover supplemental contextual information for the event to improve the contextual dictionary 130.

Consider the example in which an event to be transcribed is a meeting between department heads of an organization. The names of the department heads, talking points for the meeting, etc., are discovered as contextual information for the event from attendee/presenter lists, a meeting invitation, an attached presentation, etc. However, if the department heads were to discuss their subordinates by name (e.g., to discuss assigning action items), the names of the subordinates may not be present in the data searched for contextual information, and the contextual dictionary 130 may miss-weight the names of the subordinates, thus reducing the accuracy of the transcript, and requiring additional computing resources to correct the transcript. Instead, by querying the graph database for persons or documents related to the department heads, even when those persons or documents are not indicated in the event, the contextual dictionary 130 can be expanded to include or reweight terms and names discovered that may be spoken during the event.

For example, graph queries specify one or more of: nodes within X hops from a starting node, nodes having a node type of Y (e.g., person, place, thing, meeting, document), with a strength of at least Z, to specify what nodes are discovered and returned to augment the contextual dictionary 130 with supplemental contextual data. To illustrate in relation to the above example of a department head meeting, graph queries may specify (but are not limited to), the n most recently accessed documents for each department head, the p persons with whom each department head emails most frequently, the m most recently accessed documents for the p persons with whom each department head emails most frequently, all of the persons who have accessed the n most recently accessed documents, etc.

The key values (e.g., identity information) for the nodes discovered by spanning the graph database are used to discover the entities in various file repositories and databases. The names and terms from the data retrieved are parsed and are used as supplemental contextual information to augment the contextual dictionary 130. In various aspects, supplemental contextual information are given lower weights or less effect on existing weights of entries in the contextual dictionary 130 than contextual information.

The transcript database 140 stores one or more transcripts of textualized speech data received from the speech to text engine 120. The transcripts are synchronized with the audiovisual data to enable the provision of text in association with the audio used to produce that text. In various aspects, the transcripts are provided to the transcript database 140 as a stream while they are being produced by the speech to text engine 120 along with the audiovisual data to be transmitted, and may provide a complete or incomplete transcript for the audio visual data item at a given time. For example, a transcript may omit portions of the audiovisual content item to be transcribed when transcription began after the audiovisual content item began, thus leaving out the earlier portions of the content item from the transcript. In another example, an audiovisual content item may not be complete (e.g., a teleconference or other live event is ongoing), and the transcript, while up-to-date, is also not yet complete and is open to receive additional text data as additional audio data are received.

In various aspects, the transcript is provided to audience devices 150 and/or the audiovisual data source 110 for inclusion as captions to the audiovisual data. In other aspects, the transcript is provided to audience devices 150 as a text readout of the audiovisual data, regardless of whether the audience device 150 has received the audiovisual data on which the text data are based. The text data may be transmitted in band or out of band with any transmission of the audiovisual data according to broadcast standards, and may be incorporated into a stored version of the audiovisuals data or stored separately.

The audience device 150 in various aspects receives the audiovisual data and the transcript from the audiovisual data source 110 and the transcript database 140 respectively. In other aspects, the audience device 150 receives the transcript integrated into the audiovisual data received from the audiovisual data source 110. In yet other aspects, the audience device 150 receives the transcript from the transcript database 140 without receiving the audiovisual data from the audiovisual data source 110. In some aspects, the audience device 150 is in communication with the audiovisual data source 110 and the transcript database 140 to request changes in the content provided (e.g., request a transcript in a different language, request a different content item, to transmit feedback), while in other aspects, such as in a teleconference, the audience device 150 is an audiovisual data source 110 for its audiovisual data source 110 (which acts as an audience device 150 in turn).

Audience devices 150 that receive the audiovisual data may be either active or passive in regard to the transcript, and the collection of audience devices 150 may include both active and passive devices. Passive audience devices 150 request and receive the transcription on demand, but the user does not suggest changes to the transcript's content (due to user choice or device capabilities), whereas active audience devices 150 request and receive the transcription on demand as well as suggest changes to the transcript. A modified transcript may be local to the active audience device 150 that made the change or may be shared with other audience devices 150. Suggested changes to be shared transcript are collected from active audience devices 150 by an aggregation engine 160, which determines whether a suggested edit is to be implemented to affect the transcript in the transcript database 140 or affect terminology in the contextual dictionary 130. Suggested edits from multiple audience members are aggregated for various terms and are used to determine whether to change the transcript stored in the transcription database 140 and whether to update the contextual dictionary 130 to include new words, change the weightings of existing words, or provide pronunciation/accent feedback.

The active audience devices 150 act as a control on the output of the speech to text engine 120. The active audience devices 150, operated by humans or bots, are provided the transcript for a given audiovisual content item and an interface to make modifications to that transcript. In various aspects, the active audience devices 150 are transmitted the audiovisual data and the transcript at the same time as the passive audience devices 150 are, while in other aspects various audience device 150 may receive and suggest edits to the transcript asynchronously (e.g., a first audience device 150 receives the event and transcript live, while a second audience device 150 receives the event and transcript after a delay or at a later date).

The active audience device 150 is in communication with the transcript database 140, one or more audiovisual data source 110, and the aggregation engine 160. The active audience device 150 is operable to receive the audiovisual data from the audiovisual data source 110, and in some aspects, is operable to request different content items or variants thereof (e.g., primary audio track versus secondary audio track).

The aggregation engine 160 collects edits from the audience devices 150 and determines whether the edits should be shared with other audience devices 150 by affecting the transcript stored by the transcript database 140 or affecting the contextual dictionary 130, and thereby the ongoing choices the speech to text engine 120 makes when continuing to transcribe the event. Various audience thresholds are used by the aggregation engine 160 to determine whether an edit suggested by one or more audience devices 150 should be shared with the rest of the audience. The thresholds prevent an audience device 150 making bad edits from affecting the contextual dictionary 130 or the transcript shared with other audience devices 150. Bad edits may be the result of an audience member intentionally or unintentionally selecting a replacement word (or words) that do not improve the accuracy of the transcript, or actively degrade the accuracy of the transcript. For example, a user may miss-click a suggested word in an editor interface; selecting a wrong replacement for the text item selected. In another example, a user may maliciously suggest rude phrases or nonsensical text to disrupt the viewing experience of other users. In a further example, a user may legitimately believe that a suggested edit will improve the accuracy of the transcript, but is mistaken.

Audience thresholds provide safeguards that prevent bad edits from negatively impacting the transcript, but also incorporate machine learning models of good editing trends to automatically improve the transcript and contextual dictionary 130. For example, an aggregation engine 160 may set an audience threshold so that at least x % of the audience devices 150 must suggest the same edit before it is approved to affect the shared transcript or the contextual dictionary 130. In another example, a suggested edit must meet a given confidence threshold for the phonemes of the word(s) that it is to replace before the audience threshold is met. Audience devices 150 that are associated with a sufficient number of good edits for a given event, or that are designated as trusted editors, may be given greater weight than audience devices 150 not associated with a sufficient number of good edits (or are associated with a sufficient number of bad edits).

In some aspects, trends in edits to an event's transcript are tracked by an artificial intelligence model so that accents and pronunciation patterns observed via edits made by the one or more audience devices 150 are incorporated into the contextual dictionary 130. For example, if the transcript includes the terms “SVL”, “Van Anna”, and “very” that are corrected to “SBL”, “banana”, and “berry”, respectively, the aggregation engine 160 will detect a trend (V/B switching in this example) and update the transcript and the contextual dictionary 130 accordingly to improve the accuracy of the transcript. In various aspects, trends may be identified by fewer audience devices 150 for a single term replacement edit to satisfy the audience threshold. Continuing the above example, where an audience threshold for single word correction is satisfied when n audience devices 150 agree on an edit, the V/B switching trend may be detected by n−1 audience devices suggesting “SBL”, “banana”, and “berry” for “SVL”, “Van Anna”, and “very”. Trend detection is also operable to identify terms to add to the contextual dictionary 130 or affect the associated weighting. For example, if the word “smith” is frequently corrected to the name “Smith” for an event's transcript, the trend will be detected so that ongoing determinations of whether to provide the word or the name will more frequently choose to provide the name. Other example trends that may be recognized by the aggregation engine 160 include, but are not limited to: speech impediment correction, accent correction, idiom misuse, non-standard pronunciation/mispronunciation detection (e.g., “I triple E” corrected to “IEEE”, for [ [symbol] Il [symbol] ] rendered as “Oiler” corrected to “Euler”, the mispronunciation “aww re” [ [symbol] ′ [symbol] i] corrected to “awry” [ [symbol] ′ [symbol] aI]), spelling convention detection (e.g., American English versus British English), etc.

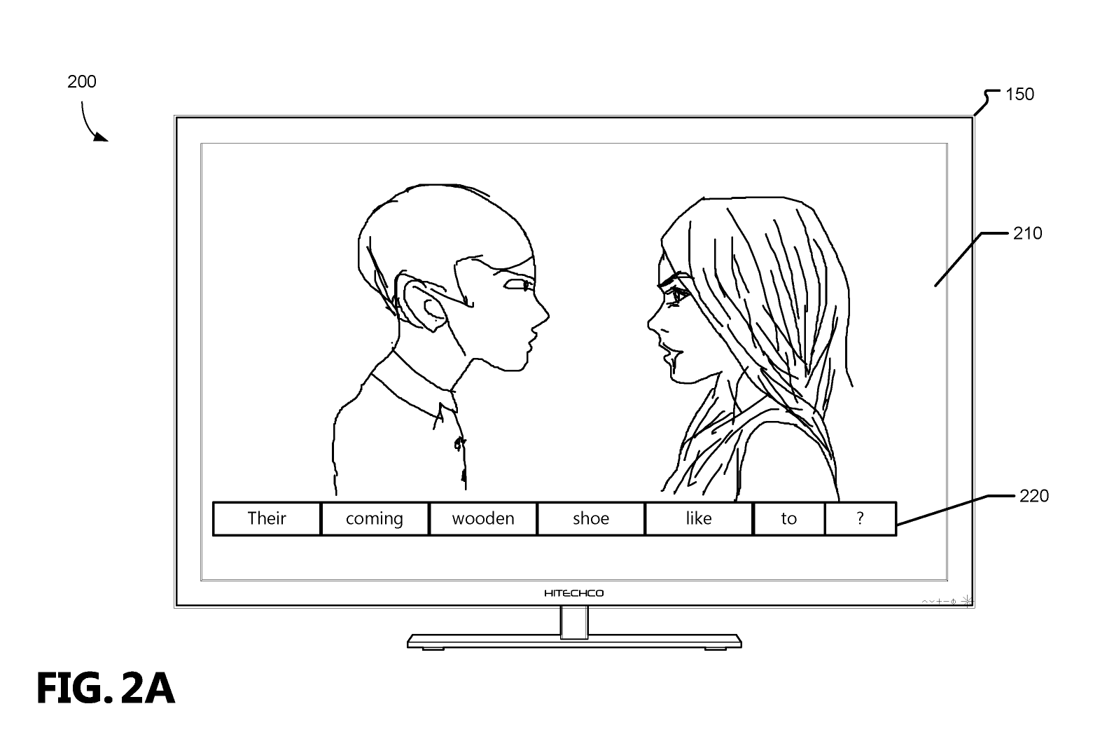

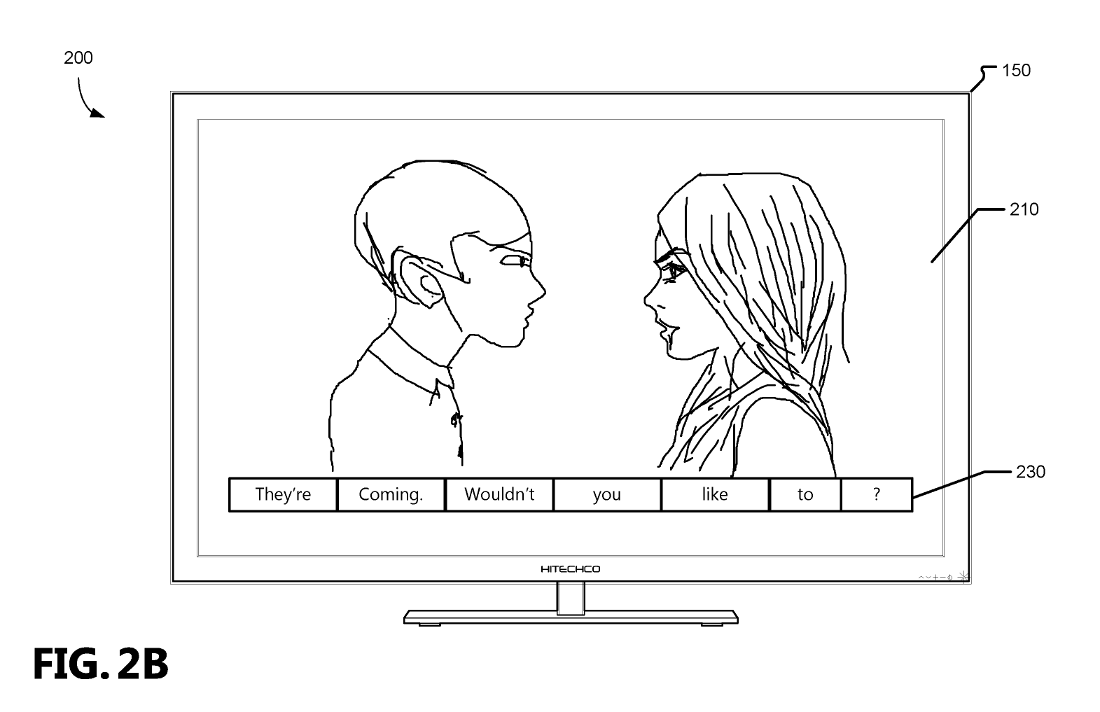

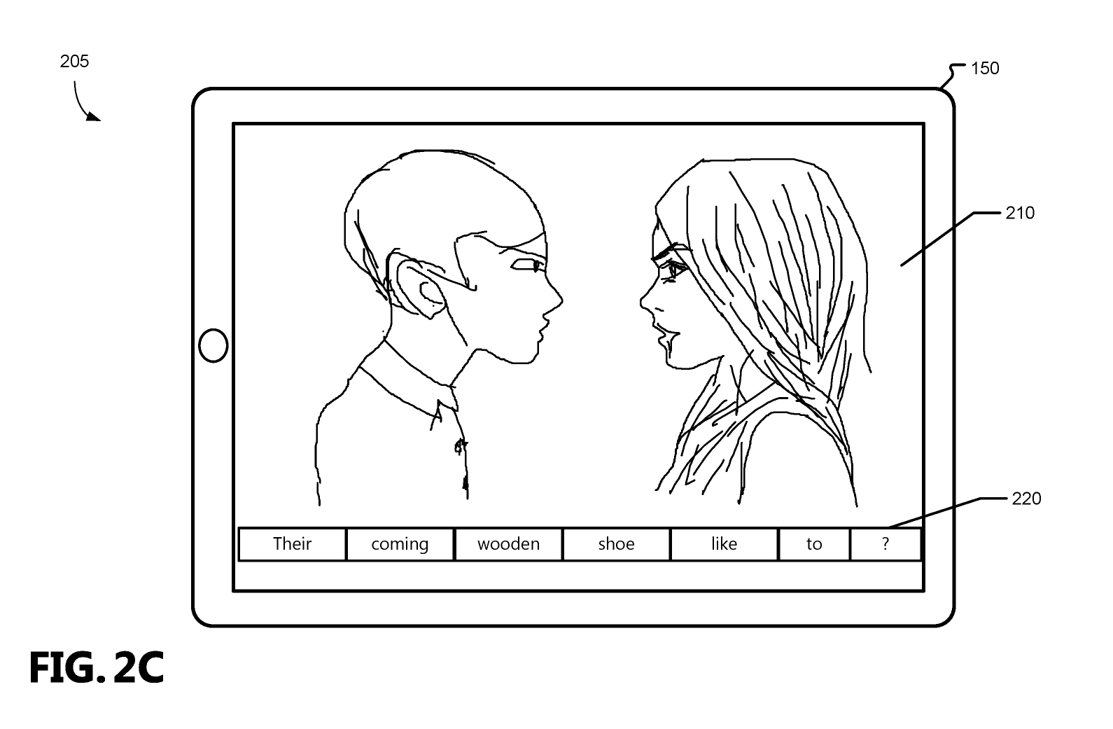

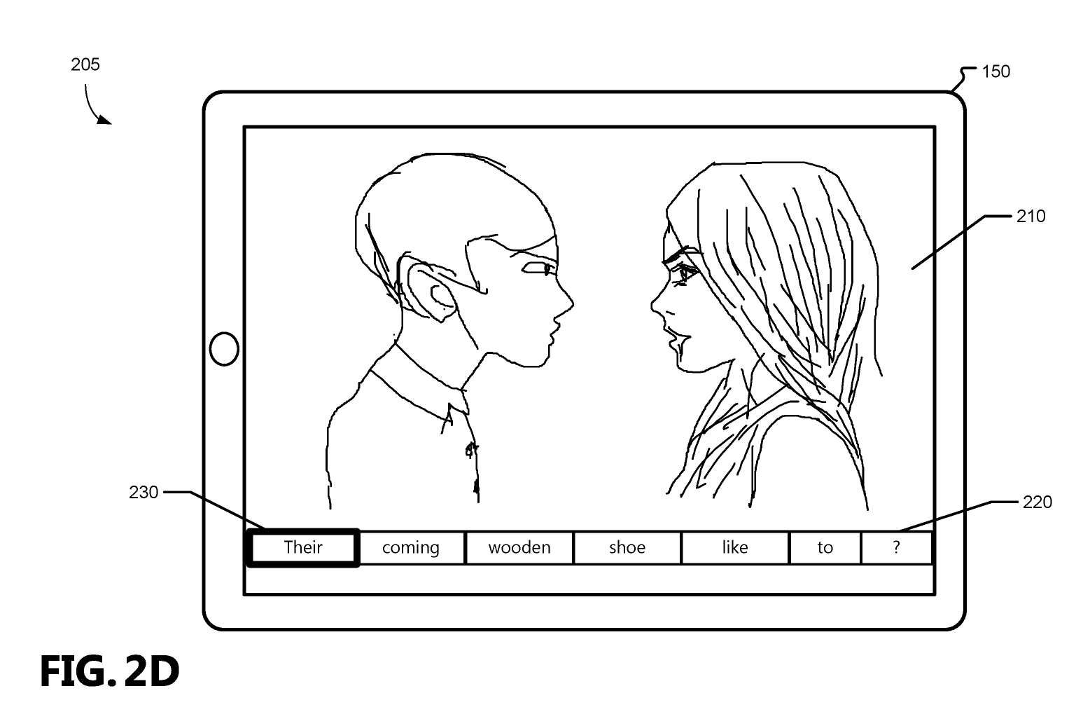

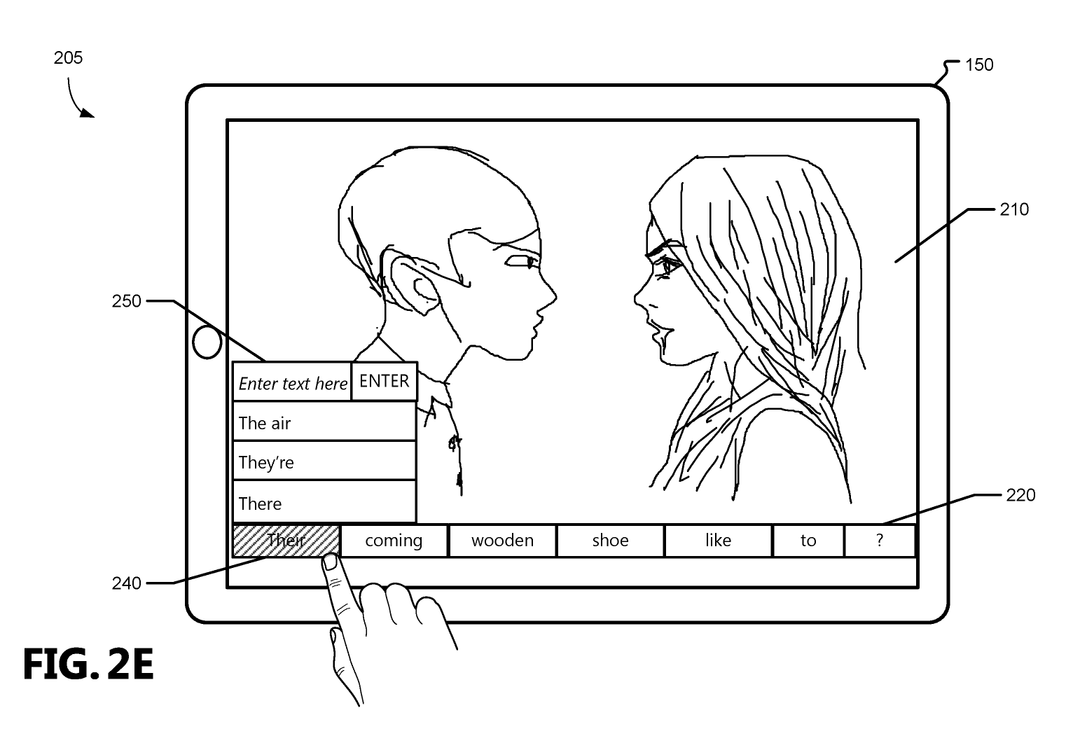

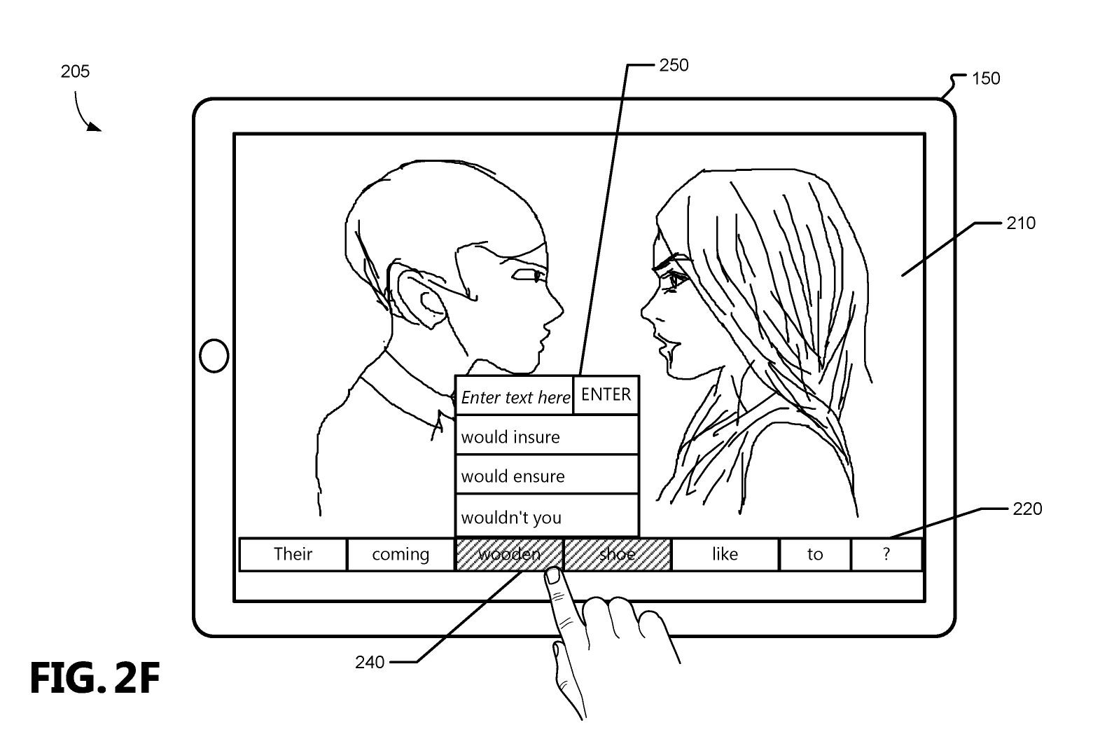

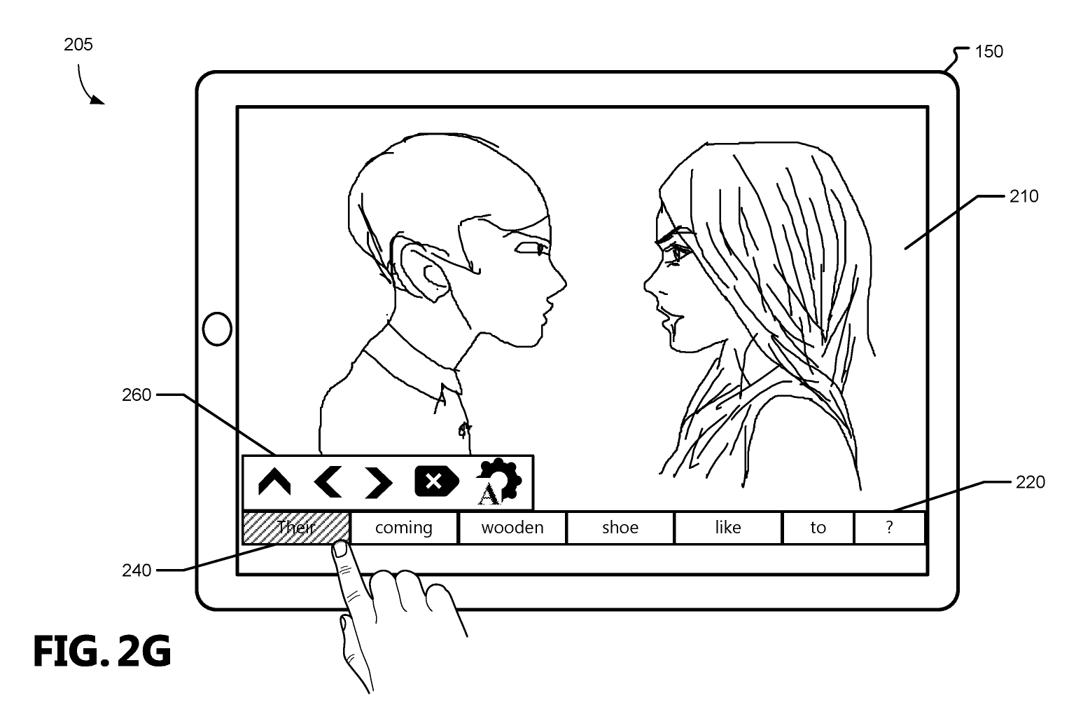

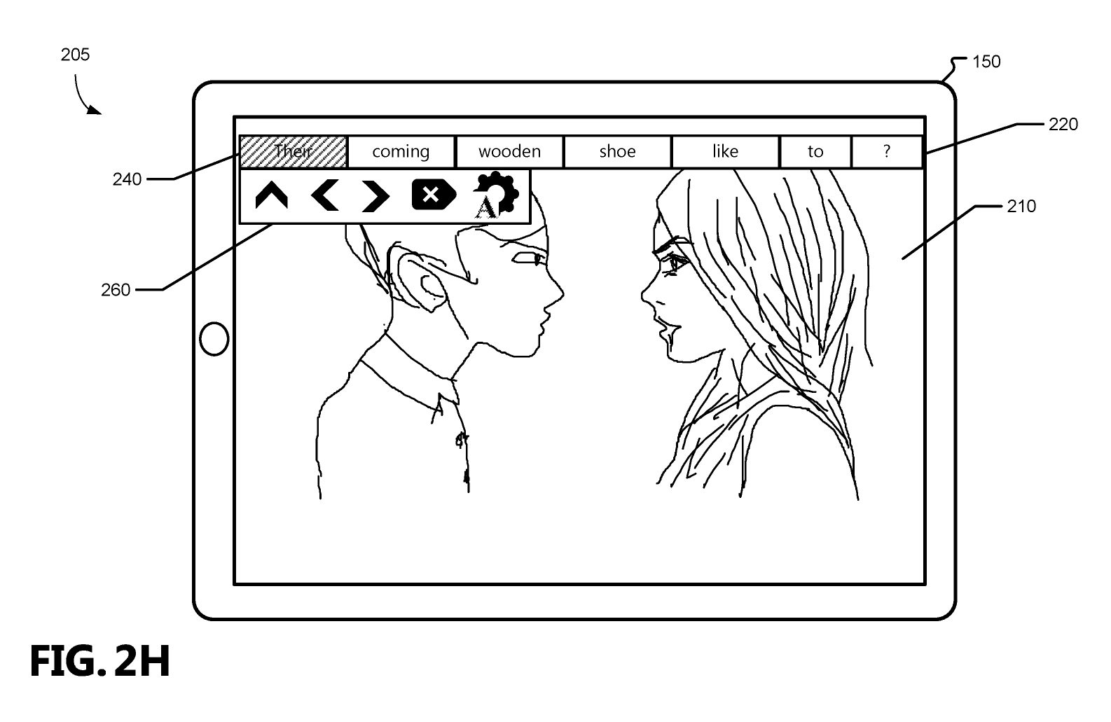

The active audience devices 150 are provided the audiovisual data in concert with the transcript to see the transcript relative to the audiovisual data, and an editor interface to modify that transcript as it is being presented relative to the audiovisual data. The user interface to modify the transcripts is discussed in greater detail in regard to the examples given in FIGS. 2A-4B, but is provided to the user of the active audience devices 150 to quickly identify text items in the transcript that are improperly formatted (e.g., wrong choice of word(s), improper capitalization, homonym or spelling confusion) and replace them in the flow of text presented along with the audiovisual data. In various aspects, the active audience devices 150 are further operable to set or modify formatting information for the text of the transcript. For example, a color or location of the text items as displayed to the audience devices 150 may be set or changed by the active audience devices 150 to indicate a party who is speaking (e.g., blue for speaker A, red for speaker B, bottom of the screen for on-screen speakers, top of the screen for narrators or off-screen speakers).

FIG. 2A illustrates an example display interface 200 showing example audiovisual content 210 with example captioning 220 related to the audiovisual content 210 as would be seen on an audience device 150 without correction. As is shown in FIG. 2A, the audience device 150 displays the audiovisual content 210, in this example, a dialog between two persons, and captioning 220 corresponding to the audio portion of the audiovisual content 210 is also displayed. As will be appreciated, the captioning 220 displayed on the audience device 150 is based on the transcript produced by the speech to text engine 120, and will be periodically updated as the audiovisual content progresses so that text corresponding to already spoken dialog will be removed from the display after a read time has expired and/or additional captioning 220 needs to occupy the space used to display the current captioning 220. As will be appreciated, as different audience devices 150 may have different display device properties (including playback window properties), the audiovisual content 210 and captioning 220 may be formatted differently on different devices (e.g., provided with a matte or border to fit an aspect ratio, captioning resized/reordered on the screen to fit available real estate and reading-size constraints).

FIG. 2B illustrates an example display interface 200 showing example audiovisual content 210 with example captioning 220 related to the audiovisual content 210 as would be seen on an audience device 150 with correction. As is shown, the text “their coming wooden shoe like to?” from FIG. 2A has been corrected to “they're coming wouldn't you like to?” in FIG. 2B. In various aspects, FIG. 2B represents a subsequent viewing of the audiovisual content 210 shown in FIG. 2A after an audience member has corrected the textual data. In various aspects, the editor may be the user of the illustrated audience device 150 or one or more other audience device 150 users, aggregated by the aggregation engine 160 to affect the transcript. In other aspects, FIG. 2B represents an initial viewing of the audiovisual content 210 in which the editor has corrected the transcript, and FIG. 2A a hypothetical viewing of the audiovisual content 210 had an editor not corrected the transcript.

FIG. 2C illustrates an example editor interface 205 showing example audiovisual content 210 with example captioning 220 related to the audiovisual content 210 as would be seen on an active audience device 150. Although the active audience device 150 is illustrated as a touchscreen enabled device in FIG. 2C, it will be appreciated that non-touch-enabled devices are also operable to act as active audience device 150, in which case a cursor may be displayed in the editor interface 205. As will be appreciated, the audiovisual content 210 are shown as they are to the passive audience devices 150 along with the corresponding captioning 220, but in various aspects, the audiovisual content 210 and captioning 220 can be formatted to account for different display device properties between given audience devices 150 (e.g., matted to accommodate different aspect ratios, captioning rearranged to fit available space on the screen, resized to retain readability attributes).

FIG. 2D illustrates an example editor interface 205 showing example audiovisual content 210 with example captioning 220 related to the audiovisual content 210 as would be seen on an active audience device 150, with a suspicious text item 230 of the example captioning 220 highlighted. A suspicious text item 230, in various aspects, is one or more words in the transcript that are designated by the speech to text engine 120 as falling below a given confidence threshold. A suspicious text item 230 may need correction, or may be a text item that is correct, but that the speech to text engine 120 is unsure of. For example, as shown in FIG. 2D, the text item of “their” has been highlighted as a suspicious text item 230, which may be due to the homophones of “their”, “they're”, and “there” providing strong confidences for the same phonemes, with no one text item having a confidence score above a threshold as being the best match—the speech to text engine 120 has selected the text item for which it is most confident, but is suspicious of its own choice. In another example, the speech to text engine 120 may mark a given text item as a suspicious text item 230, when the phonemes are unintelligible or do not provide a confidence score for any of the options exceeding a confidence threshold. Although the highlighting of the suspicious text item 230 in FIG. 2D is illustrated as a box surrounding the suspicious text item 230, other methods of highlighting of drawing the user's attention to the suspicious text item 230 may also be employed in addition to or instead of the illustrated box effect. For example different colors, font styles, typefaces, animation effects, etc., may be employed to draw the user's attention to a text item deemed suspicious.

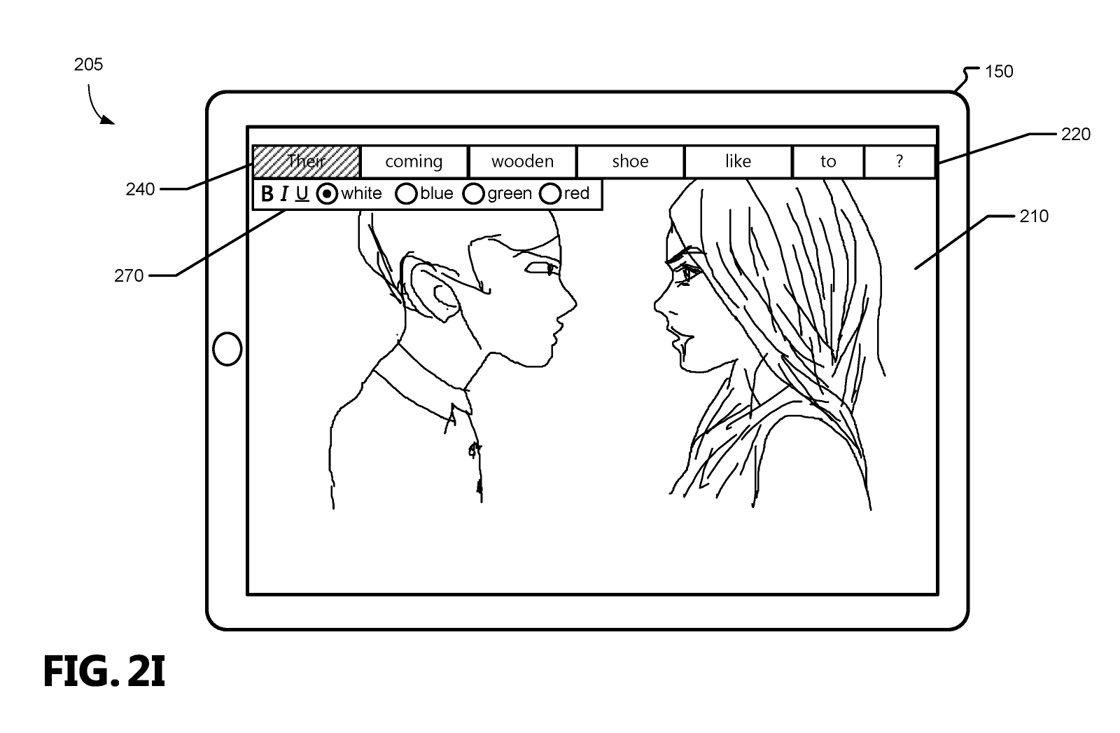

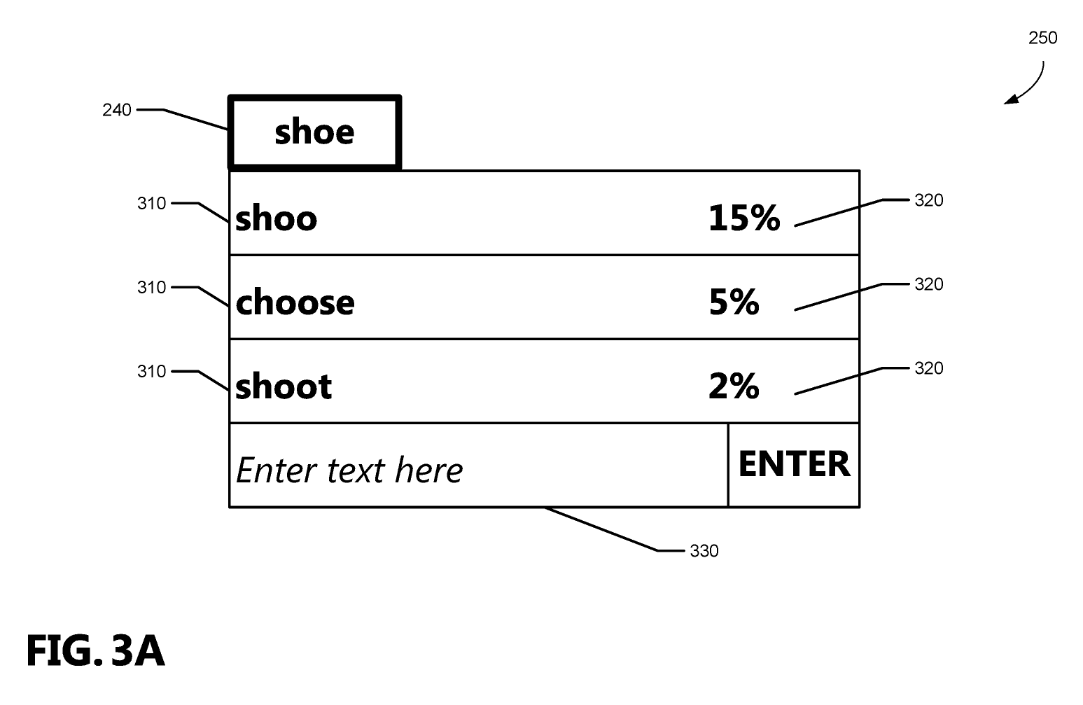

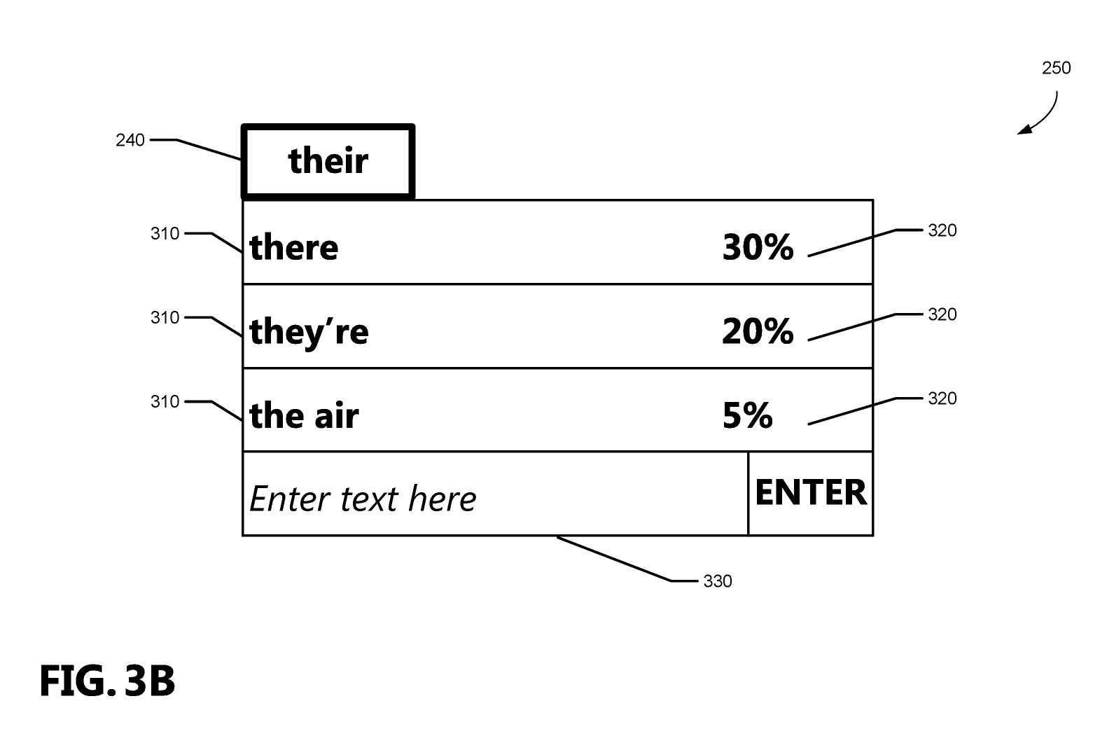

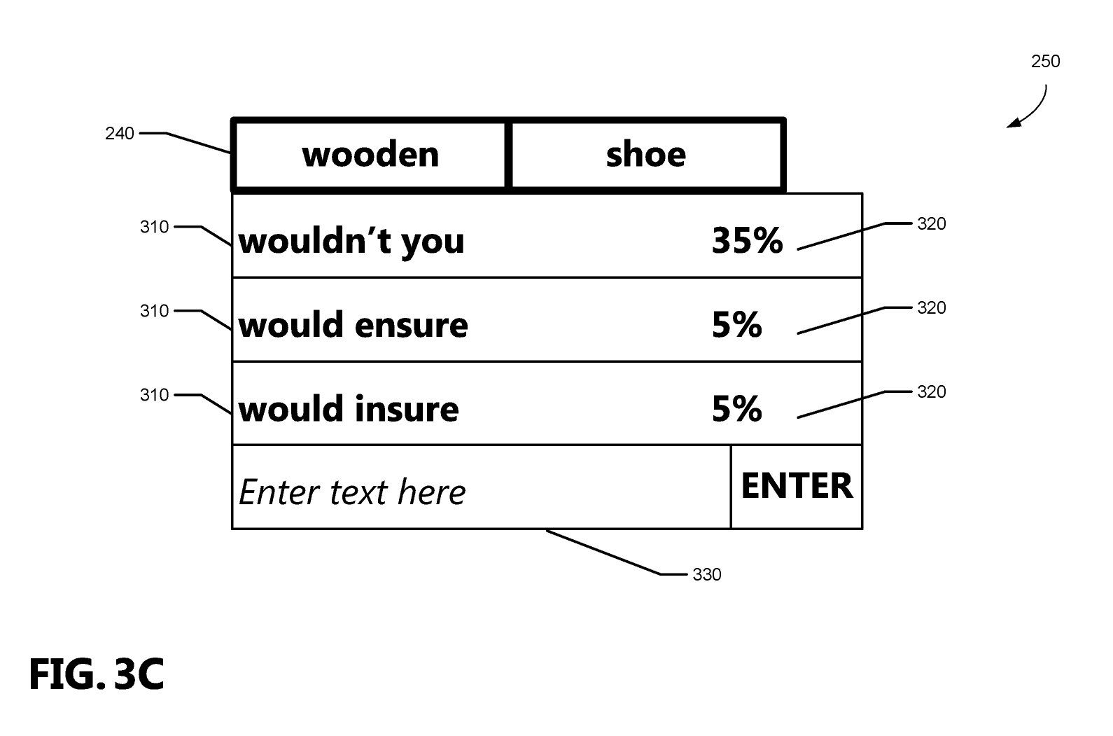

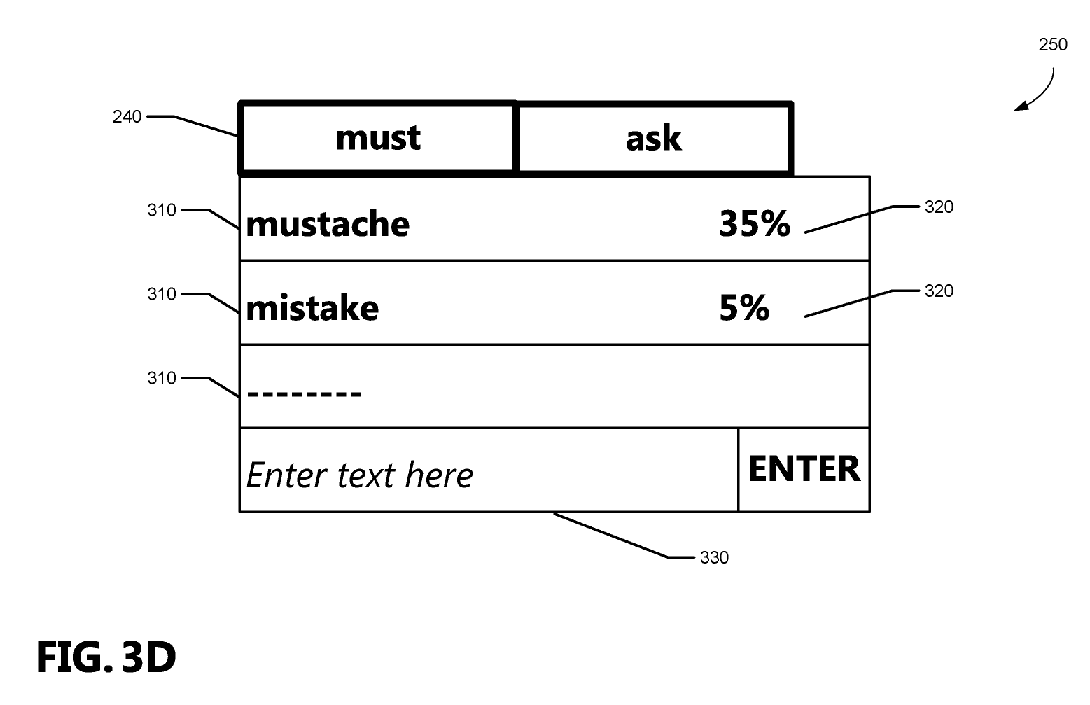

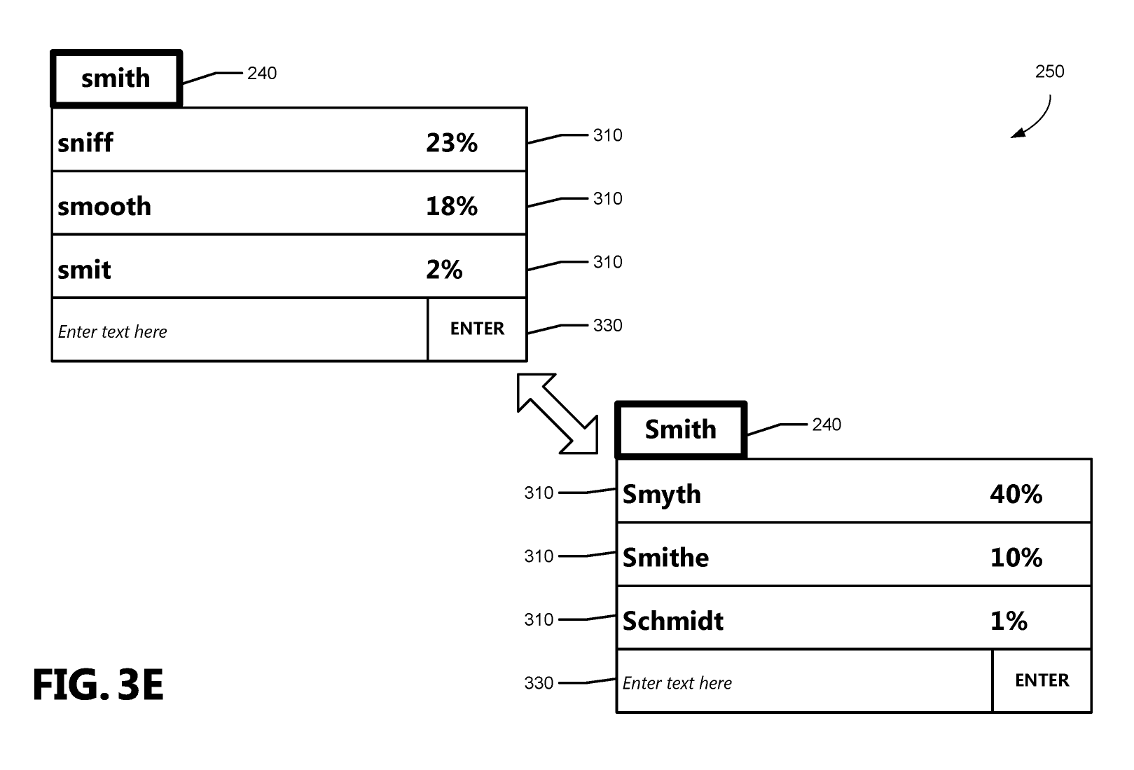

FIGS. 2E and 2F illustrate example editor interfaces 205, in which a selected text item 240 of the captioning 220 is shown with an associated replacement interface 250. In FIG. 2E one word from the captioning 220 is shown as the selected text item 240 while in FIG. 2F multiple words from the captioning 220 are shown as the selected text item 240. Replacement interfaces 250 are configured to provide the n-best text items after the currently presented text item as potential replacements for the selected text item 240. Replacement interfaces 250 are described in greater detail in regard to FIGS. 3A-3E. In various aspects, when a text object of the captioning 220 is selected, it is shown with a highlight/lowlight effect to indicate its selection as a selected text item 240, and a replacement interface 250 is shown in association with the text object. Depending on user preferences, and screen space relative to the text item, the replacement interface 250 is displayed above, below, to the right, or to the left of the selected text item 240 and is formatted accordingly. Further, according to one aspect, the selected text items 240 are continually shown with an associated replacement interface 250 after the text items are no longer the currently presented captions to be displayed such that although live captions may continue to be provided (e.g., on a separate line) in concert with the audiovisual content, the replacement interface 250 will continue to be displayed until a selection is made or it is otherwise dismissed. The currently presented captions and the selected text items 240 may coexist at different locations on the display, which allows the user to continue editing the selected text items 240 while viewing the current captions.

FIGS. 2G and 2H illustrate example editor interfaces 205, in which a selected text item 240 of the captioning 220 is shown with an associated formatting interface 260. The formatting interface 260 provides one or more controls operable to change the relative position of the captioning 220 to the audiovisual content 210, to delete a selected text item 240, and to change settings for how the captioning 220 is displayed, such, as, for example, typeface, font size, font effect (bold/italic/underline), and color.

FIG. 2G illustrates the captioning 220 positioned on the bottom edge of the audiovisual content 210, with the formatting interface 260 extending upward into available space over the audiovisual content 210, whereas FIG. 2H illustrates the captioning 220 positioned on the upper edge of the audiovisual content 210, with the formatting interface 260 extending downward into available space over the audiovisual content 210. In various aspects, the formatting interface 260 is invoked as a sub-interface of the replacement interface 250 (e.g., through a menu-driven system), as a right-click when the replacement interface 250 is called via a left-click, through a distinct gesture (e.g., hold to invoke), multi-touch input (e.g., two-finger touch to invoke) or voice command from that used to invoke the replacement interface 250.

FIG. 2I illustrates an example editor interface 205, in which an enriching interface 270 is displayed. In various aspects, the enriching interface 270 is invoked or presented as a sub-interface of the replacement interface 250 or formatting interface 260 (e.g., through a menu-driven system), as a middle-click when the replacement interface 250 is called via a left-click and the formatting interface 260 via a right click, through a distinct gesture, multi-touch input (e.g., three-finger touch to invoke) or voice command from that used to invoke the replacement interface 250. The enriching interface 270 is configured to provide several options to apply, set, or alter richtext features to the selected text item 240 in the captioning 220 and the transcript, such as, for example, font effects, text colors, typefaces, font sizes, etc.

FIGS. 3A-3E illustrate example replacement interfaces 250. Each illustrated replacement interface 250 is displayed in association with the selected text item 240 with one or more suggested text items 310 to substitute for the selected text item 240. As illustrated, three suggested text items 310 are provided in the replacement interfaces 250, but more or fewer suggestions may be included in other aspects. In various aspects, the suggested text items 310 are displayed with a confidence indicator 320, which indicates a level of confidence from the speech to text engine 120 in the suggested text item 310 being the best match for the selected text item 240. A custom entry control 330 is also provided to enable a user to specify a replacement text item other than those initially presented as suggested text items 310 and/or to provide filtering for suggested text items 310.

FIG. 3A illustrates an example replacement interface 250, in which a selected text item 240, representing one word has been selected, and several single-word suggested text items 310 are provided. In the illustrated example, the word “shoe” was selected from the phonemes of the speech data, by the speech to text engine 120 or by user-correction of results from the speech to text engine 120, and the three next-best selections for those phonemes, as determined by the speech to text engine 120 or specified in the contextual dictionary 130, are provided as the suggested text items 310. In the illustrated example, the three next-best selections for the phonemes associated with “shoe” are: “shoo”, “choose”, and “shoot”, which are presented with confidence indicators 320 displaying the relative confidence between each option.

The confidences, in various aspects, are based on phonetic similarities, grammatical and syntactical relations to other words (e.g., other words identified in the transcript will affect the confidence score to produce a grammatically/syntactically more correct sentence), and prior user configuration or correction of the transcript. Although shown as numerical percentages, confidence indicators 320 also include, but are not limited to: color-coded indicators, emoji, bar graphs/meters, and the like. In some aspects, the confidence indicators 320 may be omitted or hidden, and a relative confidence between suggested text items 310 may be represented by an order in which the suggested text items 310 are presented in the replacement interface 250.

When a suggested text item 310 is selected from the replacement interface 250, the suggested text item 310 will replace the selected text item 240 in the captioning 220 and the transcript, and the confidence assigned to the suggested text item 310 and the former selected text item 240 will be adjusted upward and downward accordingly to affect future speech to text conversions. In various aspects, a selection of a suggested text item 310 will close the replacement interface 250 or make the suggested text item 310 the selected text item 240 and leave the replacement interface 250 open to receive additional input from the users.

FIG. 3B illustrates an example replacement interface 250, in which a selected text item 240 representing one word has been selected, and several suggested text items 310 representing one or more words are provided. Because a given set of phonemes may be interpreted as representing one word or many words, the suggested text items 310 presented to the user may include multiple words when the selected text item 240 represents one word. As illustrated, the individual word “their” of the selected text item 240 is interpreted also as the individual word of “there”, the contraction “they're”, and as multiple words of “the air” based on the phonetic similarities between the selected text item 240 and the suggested text items 310.

FIG. 3C illustrates an example replacement interface 250, in which a selected text item 240 representing multiple words has been selected, and several suggested text items 310 representing multiple words are provided. Because a given set of phonemes may be interpreted as representing one word or many words, the suggested text items 310 presented to the user may include multiple words when the selected text item 240 represents multiple words. As illustrated, the multiple words “wooden shoe” of the selected text item 240 are interpreted also as the multiple words of “wouldn't you”, “would ensure”, and “would insure” based on the phonetic similarities between the selected text item 240 and the suggested text items 310.

FIG. 3D illustrates an example replacement interface 250, in which a selected text item 240 representing multiple words has been selected, and several suggested text items 310 representing single words are provided. Because a given set of phonemes may be interpreted as representing one word or many words, the suggested text items 310 presented to the user may include individual words when the selected text item 240 represents multiple words. As illustrated, the multiple words “must ask” of the selected text item 240 are interpreted also as the individual words of “mustache” and “mistake” based on the phonetic similarities between the selected text item 240 and the suggested text items 310.

In various aspects, when the replacement interface 250 provides the n best substitutions for the selected text item 240 found in the contextual dictionary 130, but less than n entries are found, blank positions may be provided in the replacement interface 250, or the empty positions may not be displayed; providing a smaller replacement interface 250. As illustrated in FIG. 3D, a third suggested text item position in the replacement interface 250 is left blank, indicating that no third entry from the contextual dictionary 130 was found to present to the user.

FIG. 3E illustrates an example replacement interface 250, in which the user makes formatting changes to the selected text item 240 and the several suggested text items 310 provided are updated accordingly. For example, a user may select a given text item from the captioning 220 to correct a case of the item, or correct both the case and the choice of words representing the text item. For example, the proper name “Smyth” may initially appear in the captioning 220 as “smith” due to their phonetic similarities. The user, having selected a control or input a gesture (e.g., a button, a multi-finger selection of the selected text item 240) associated with changing formatting, will then be presented with a reformatted version of the selected text item 240 and the suggested text items 310 are updated accordingly to reflect the formatting scheme used for the selected text item 240. Formatting schemes include, but are not limited to: changing capitalization, changing writing system (e.g., katakana to hiragana, Latin to Cyrillic, traditional Chinese to simplified Chinese), adding or removing accent marks or ruby characters, etc. In various aspects, capitalization schemes include: all lowercase, first letter uppercase, sentence case (first word's first letter uppercase, subsequent lowercase), all uppercase, intelligent camel case (e.g., capitalizing one or more letters in a word based on recognized patterns, such as, in “McCool”, “MacDonald”, or “O'Mary”).

The replacement interface 250 provides suggestions based on the selected formatting so that the suggested text items 310 for one formatting option may be different from those in another formatting option. As illustrated, the suggested text items 310 for lowercase “smith” are “sniff”, “smooth”, and “smit”, whereas the suggested text items 310 for uppercase “Smith” are “Smyth”, “Smithe”, and “Schmidt”. In various aspects, the user may elect to change the formatting of the selected text item 240 without choosing a suggested text item 310, in which case the captioning 220 and transcript are updated to the new format. In other aspects, the user may elect to change a suggested text item 310 along with the formatting change, in which case the captioning 220 and transcript are updated to the suggested text item 310 that is selected by the user.

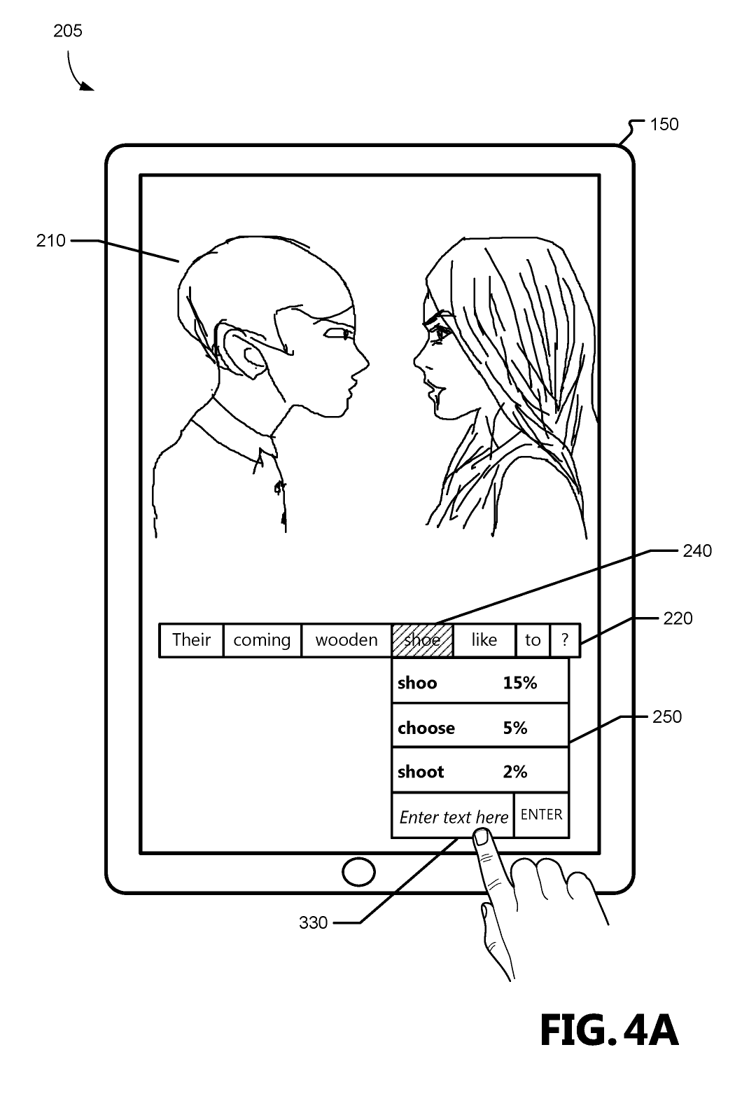

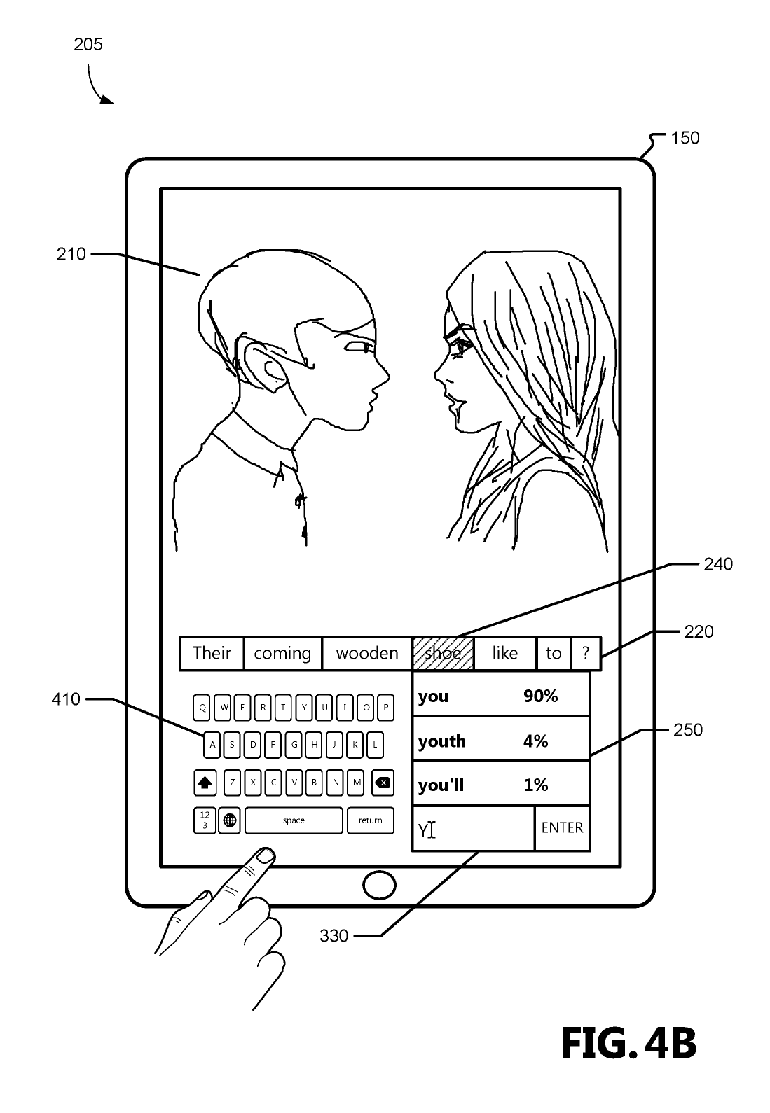

FIGS. 4A and 4B illustrate example editor interfaces 205, in which a custom entry control 330 of a replacement interface 250 has been selected. The custom entry control 330 is configured to accept text input to provide user-defined words to replace the selected text item 240 in the transcript, and/or additional or different suggested text items 230 based on the text input.

FIG. 4A illustrates an initial state of the editor interface 205 in which the selected text item 240 from the captioning 220 of the audiovisual content 210 is “shoe”, and the suggested text items 310 are “shoo”, “choose”, and “shoot”. FIG. 4B illustrates a subsequent state of the editor interface 205 in which the user has selected the custom entry control 330 (e.g., by providing focus to a textbox of the custom entry control 330), an onscreen keyboard 410 is (optionally) provided, the user has input the letter “y” into the textbox of the custom entry control 330, and the suggested text items 310 are “you”, “youth”, and “you'll”. The suggested text items 310 are the n-best words (or groups of words) that comply with the text entered into the textbox. For example, although the speech to text engine 120 initially selected “shoo”, “choose”, and “shoot” as the three best alternatives for the phonemes identified as “shoe”, when “y” is specified as the first letter of the actual word, the text engine 120 will provide the three best alternative for the phonemes identified as “shoe” that start with the letter “y”.

In some aspects, a spell-checker is integrated into or is in communication with the custom entry control 330 to enable misspelled words to return correctly spelled words as suggested text items 310. The user is enabled to select a suggested text item 310 to replace the selected text item 240, or may fully input (via a hardware keyboard, onscreen keyboard 410, gesture to character recognition, speech to text conversion, etc.) a word into the textbox and signal that it is to replace the selected text item 240 in the transcript and captioning 220.

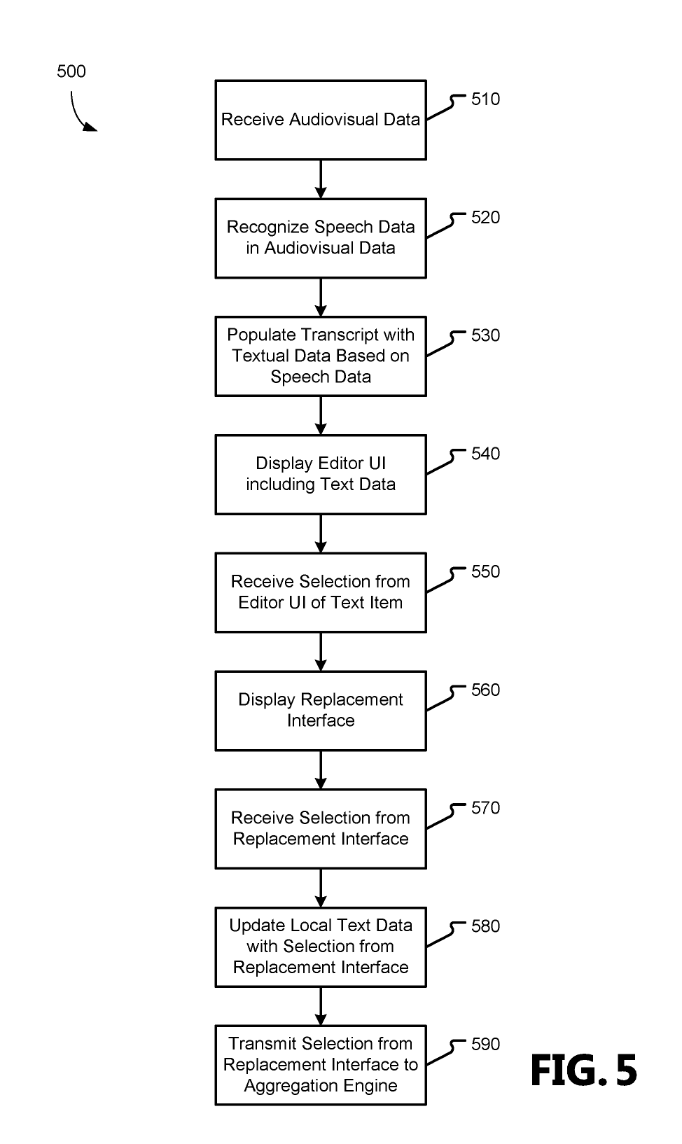

FIG. 5 is a flow chart showing general stages involved in an example method 500 for real-time caption correction by an audience member. Method 500 begins in response to audiovisual data being received by a speech to text engine 120 at OPERATION 510. Audiovisual data include audiovisual files and streams, which include or exclude video portions (e.g., an audio stream may be treated as an audiovisual data stream with a null video track or component). At OPERATION 520 the speech data are recognized in the audio portions of the audiovisual data, which may include audio data encoded on one or more channels, that are filtered from background audio and channels including background versus foreground audio. The speech to text engine 120 populates a transcript with textual data at OPERATION 530 based on the speech data isolated and recognized in OPERATION 520.

Proceeding to OPERATION 540, the text generated at OPERATION 530 from the speech is presented for display. When the textual data are presented to an audience member, on an audience device 150, the audience member will see the textual data displayed in concert with the audiovisual data (e.g., as captions) as well as an editor interface 205 to affect the content and/or presentation of the textual data. In various aspects, one or more audience members (active or passive) receive the transcript and audiovisual data concurrently with the progressions of the event being transcribed (e.g., live during a meeting broadcast to several devices). In other aspects, different audience members may receive the same event (or portions thereof) at different times, such as with a previously recorded event or a cached portion of an ongoing event, and suggest or receive edits to the transcript in concert with the portion and time currently displayed.

The textual data are presented as plaintext or as richtext. Richtext is provided to convey emphasis, emotional mood, rate of speech, and speaker information. Richtext effects include, but are not limited to: colors of text/background, typeface, size, font effects (bold, italic, superscript, subscript, underline, etc.), capitalization schemes (e.g., all caps for yelling), and relative positions, which may be supplied by the speech to text engine 120 or by the audience members. For example, the speech to text engine 120 may detect multiple speakers based on different frequency ranges or vocal patterns in the speech data, and apply different colors to the richtext textual data supplied for those speakers. In another example, the speech to text engine 120 supplies the audience member with a plaintext transcript, which the audience member enriches with richtext effects.

A selection is received at OPERATION 550 from the audience member of one or more text items from the editor interface 205. Text items include individual words or groups of words from the presented textual data, and may be selected from the editor's interface via a mouse or other pointing device, a touchscreen interface, or spoken commands. In response to a text item of the presented transcript being selected, method 500 proceeds to OPERATION 560, where a replacement interface 250 is displayed within the editor interface 205. Various examples of editor interfaces 205 are discussed in regard to FIGS. 2A-3D.

The replacement interface 250 provides the audience member controls by which to alter the textual data of the selected text item, and in some aspects, to alter or add richtext effects to the transcript. These selections are received to the selected textual item at OPERATION 570. In various aspects, as the textual data presented in the editor interface 205 are updated in concert with the playback of the audiovisual data, if a selection is not received in the replacement interface 250 before the selected text item is removed from display, the replacement interface 250 will be removed from display without accepting a change to the textual data. In other aspects, as the textual data presented in the editor interface 205 are updated in concert with the playback of the audiovisual data, if a selection is not received in the replacement interface 250 before the selected text item is removed from display, the audience member is presented with the new textual data and the selected text item and associated replacement interface 250 remain displayed until a selection is made or focus is moved away from the replacement interface 250.

At OPERATION 580 the local text data are updated with the selection made from the replacement interface 250 on the given active audience device 150. In various aspects, the replaced terms immediately affect the selection displayed on the audience device 150 and are transmitted to the aggregation engine 160 at OPERATION 590 to determine whether to update the shared text data in the transcript database 140 and the weightings of various terms in the contextual dictionary 140. Method 500 may then conclude.

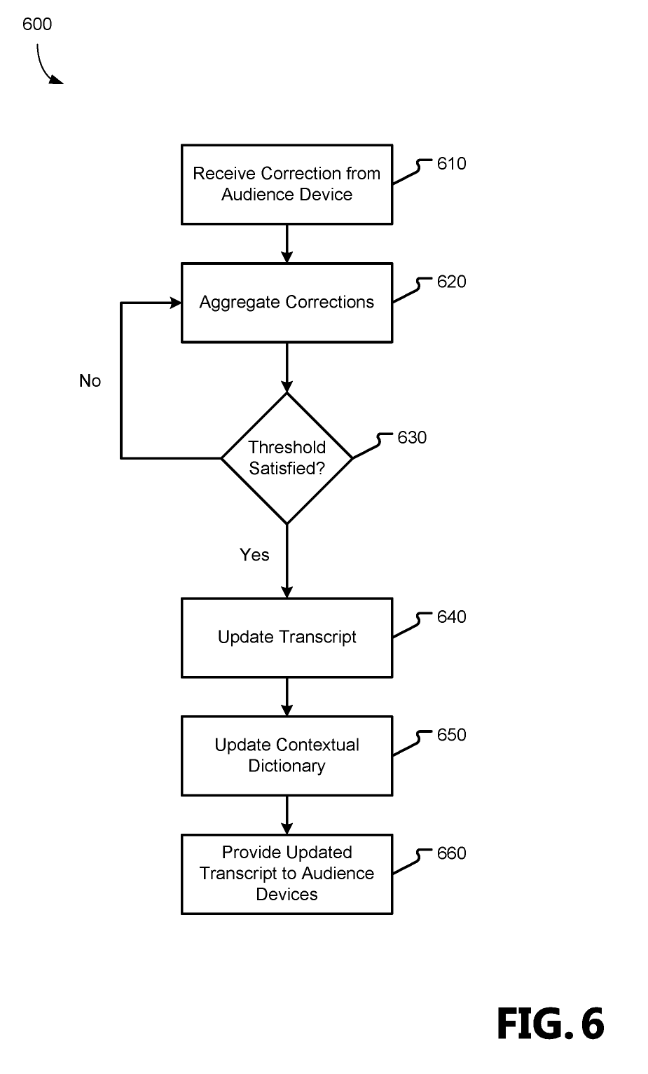

FIG. 6 is a flow chart showing general stages involved in an example method 600 for handling audience-suggested corrections to captions. Method 600 begins at OPERATION 610, where a correction to the transcript is received from an audience device 150. Suggested corrections from one or more audience devices 150 are aggregated at OPERATION 620 for the aggregation engine 160 to determine whether to implement the suggested corrections. In some aspects, the suggestions are aggregated according to individual selected terms in the transcript, which include one or more words, which the suggestions are paired against as replacement in the transcript. In additional aspects, the suggestions are analyzed to identify editing trends from a series of corrections suggested across multiple terms (from one or more audience devices 150) that are indicative of a systemic transcription discrepancy, such as, for example, the speech to text engine 120 using an improper accent recognition algorithm, hardware difficulties resulting in indistinct phonemes, etc.

At DECISION 630 it is determined whether an audience threshold has been satisfied by the suggested correction. In various aspects, a given audience device 150 has its suggestions given greater or lesser weight than other audience devices 150 in determining whether an audience threshold has been satisfied, such that trusted editors may individually satisfy an audience threshold, and (conversely) known malicious or frequently incorrect editors are ignored. For audience devices 150 assigned weights between these extremes, the audience thresholds prevent suggestions from affecting the transcript or contextual dictionary 130 until a consensus is formed that an edit should be made in the shared resources. For example, at least x audience devices 150 or y % of the audience devices 150, or z weight of audience devices 150 must agree on an edit before the audience threshold is satisfied. In another example, the suggested replacement must have a confidence score of at least n from the speech to text engine 210 for matching the phonemes of the words suggested to be replaced in the transcript. In a further example, the suggested edit must match an identified trend of other edits (previously or later suggested) to satisfy the audience threshold. As will be appreciated, other audience thresholds that combine the above examples are possible and the foregoing are presented as non-limiting examples of audience thresholds.

When it is determined that the suggested correction does not satisfy an audience threshold, method 600 returns to OPERATION 620 to continue aggregating corrections. When it is determined that the suggested correction does satisfy an audience threshold, method 600 proceeds to OPERATION 640, where the transcript is updated in the transcript database 140 to reflect the suggested correction. In various aspects, the suggested correction is a plaintext correction (affecting word choice), a richtext correction (affecting formatting), or a combination or plaintext and richtext correction.

At OPERATION 650, the aggregation engine 160 updates the contextual dictionary 130 based on the edits that satisfied the audience threshold. In various aspects, the selection influences the weight of the replaced and the replacing term in the contextual dictionary 130 so that the speech to text engine 120 will have greater confidence in selecting the replacing term over the replaced term when populating the transcript in response to observing the same (or similar) phonemes again in the audiovisual data. In additional aspects, the updated text is stored in the transcript database 140 so that when the audience is provided the transcript (for a first or a subsequent time), the selected text item is presented in place of the replaced text item.

Method 600 optionally proceeds to OPERATION 660 to provide the updated transcript to the audience devices 150. The audience devices 150 to which the updated transcript is provided include both passive audience devices 150 and active audience devices 150 that have elected to receive update transcripts and are consuming a relevant portion of the transcribed event. For example, when an audience device 150 is viewing captions that are affected by an update to the transcript, that update is transmitted to the audience device 150 so that the audience device 150 displays captions corresponding to the updated transcript instead of uncorrected captions. In another example, where an update to the transcript is made at the m minute mark of the event, but the audience device 150 has already viewed the m minute mark of the event, the updated transcript may be transmitted to the audience device 150 so that if the user re-watches the m minute mark, the corrected captions will be available, or the transcript may not be transmitted to that audience device 150 to reduce the amount of data to be transmitted. Method 600 may then conclude or continue aggregating corrections as they are received from audience devices 150.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 7-9 and the associated descriptions provide a discussion of a variety of operating environments in which examples are practiced. However, the devices and systems illustrated and discussed with respect to FIGS. 7-9 are for purposes of example and illustration and are not limiting of a vast number of computing device configurations that are utilized for practicing aspects, described herein.

FIG. 7 is a block diagram illustrating physical components (i.e., hardware) of a computing device 700 with which examples of the present disclosure may be practiced. In a basic configuration, the computing device 700 includes at least one processing unit 702 and a system memory 704. According to an aspect, depending on the configuration and type of computing device, the system memory 704 comprises, but is not limited to, volatile storage (e.g., random access memory), non-volatile storage (e.g., read-only memory), flash memory, or any combination of such memories. According to an aspect, the system memory 704 includes an operating system 705 and one or more program modules 706 suitable for running software applications 750. According to an aspect, the system memory 704 includes one or more of the audiovisual data source 110, the speech to text engine 120, the contextual dictionary 130, the transcript database 140, the aggregation engine 160 or the interfaces for the audience members. The operating system 705, for example, is suitable for controlling the operation of the computing device 700. Furthermore, aspects are practiced in conjunction with a graphics library, other operating systems, or any other application program, and are not limited to any particular application or system. This basic configuration is illustrated in FIG. 7 by those components within a dashed line 708. According to an aspect, the computing device 700 has additional features or functionality. For example, according to an aspect, the computing device 700 includes additional data storage devices (removable and/or non-removable) such as, for example, magnetic disks, optical disks, or tape. Such additional storage is illustrated in FIG. 7 by a removable storage device 709 and a non-removable storage device 710.

As stated above, according to an aspect, a number of program modules and data files are stored in the system memory 704. While executing on the processing unit 702, the program modules 706 perform processes including, but not limited to, one or more of the stages of the methods 500 and 600 illustrated in FIGS. 5 and 6. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, aspects are practiced in an electrical circuit comprising discrete electronic elements, packaged or integrated electronic chips containing logic gates, a circuit utilizing a microprocessor, or on a single chip containing electronic elements or microprocessors. For example, aspects are practiced via a system-on-a-chip (SOC) where each or many of the components illustrated in FIG. 7 are integrated onto a single integrated circuit. According to an aspect, such an SOC device includes one or more processing units, graphics units, communications units, system virtualization units and various application functionality all of which are integrated (or “burned”) onto the chip substrate as a single integrated circuit. When operating via an SOC, the functionality, described herein, is operated via application-specific logic integrated with other components of the computing device 700 on the single integrated circuit (chip). According to an aspect, aspects of the present disclosure are practiced using other technologies capable of performing logical operations such as, for example, AND, OR, and NOT, including but not limited to mechanical, optical, fluidic, and quantum technologies. In addition, aspects are practiced within a general purpose computer or in any other circuits or systems.

According to an aspect, the computing device 700 has one or more input device(s) 712 such as a keyboard, a mouse, a pen, a sound input device, a touch input device, etc. The output device(s) 714 such as a display, speakers, a printer, etc. are also included according to an aspect. The aforementioned devices are examples and others may be used. According to an aspect, the computing device 700 includes one or more communication connections 716 allowing communications with other computing devices 718. Examples of suitable communication connections 716 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. According to an aspect, any such computer storage media is part of the computing device 700. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

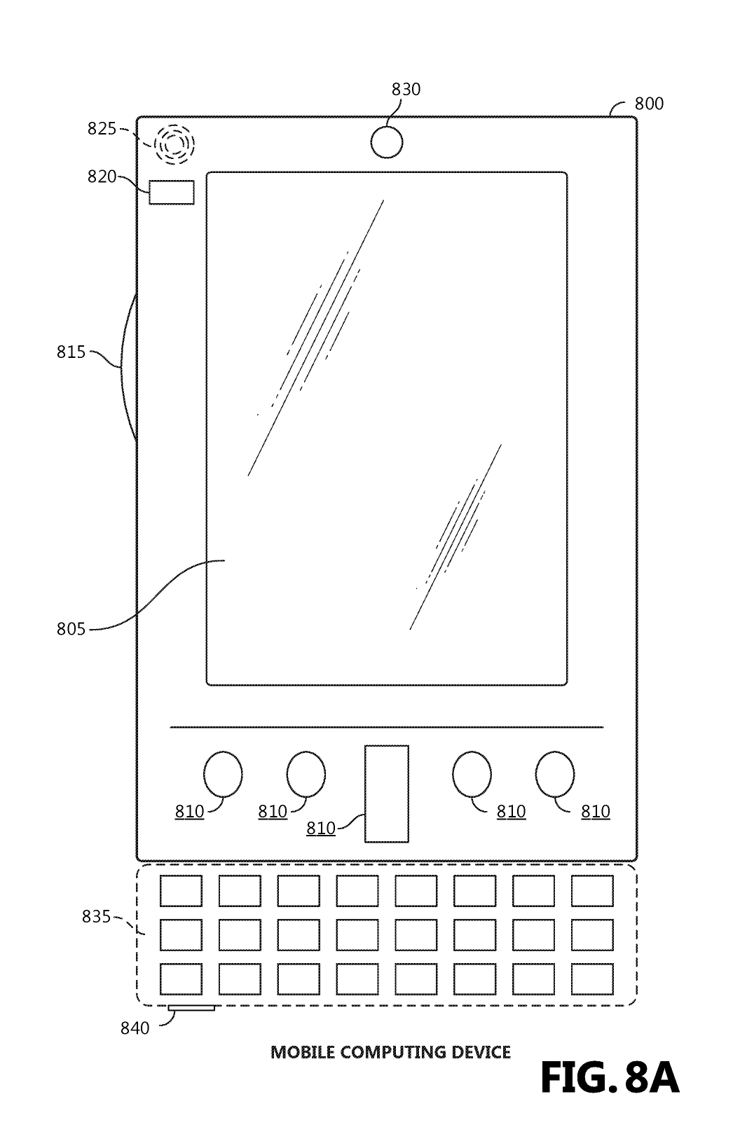

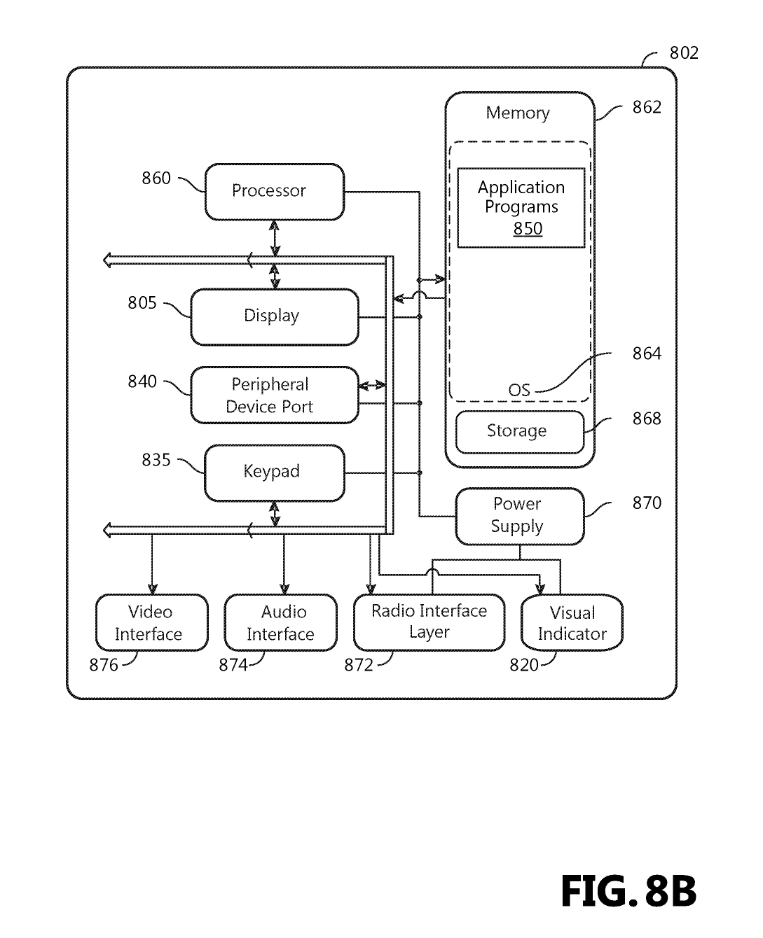

FIGS. 8A and 8B illustrate a mobile computing device 800, for example, a mobile telephone, a smart phone, a tablet personal computer, a laptop computer, and the like, with which aspects may be practiced. With reference to FIG. 8A, an example of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. According to an aspect, the display 805 of the mobile computing device 800 functions as an input device (e.g., a touch screen display). If included, an optional side input element 815 allows further user input. According to an aspect, the side input element 815 is a rotary switch, a button, or any other type of manual input element. In alternative examples, mobile computing device 800 incorporates more or fewer input elements. For example, the display 805 may not be a touch screen in some examples. In alternative examples, the mobile computing device 800 is a portable phone system, such as a cellular phone. According to an aspect, the mobile computing device 800 includes an optional keypad 835. According to an aspect, the optional keypad 835 is a physical keypad. According to another aspect, the optional keypad 835 is a “soft” keypad generated on the touch screen display. In various aspects, the output elements include the display 805 for showing a graphical user interface (GUI), a visual indicator 820 (e.g., a light emitting diode), and/or an audio transducer 825 (e.g., a speaker). In some examples, the mobile computing device 800 incorporates a vibration transducer for providing the user with tactile feedback. In yet another example, the mobile computing device 800 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 800 incorporates peripheral device port 840, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one example of a mobile computing device. That is, the mobile computing device 800 incorporates a system (i.e., an architecture) 802 to implement some examples. In one example, the system 802 is implemented as a “smart phone” capable of running one or more applications (e.g., browser, e-mail, calendaring, contact managers, messaging clients, games, and media clients/players). In some examples, the system 802 is integrated as a computing device, such as an integrated personal digital assistant (PDA) and wireless phone.

According to an aspect, one or more application programs 850 are loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 is used to store persistent information that should not be lost if the system 802 is powered down. The application programs 850 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800.

According to an aspect, the system 802 has a power supply 870, which is implemented as one or more batteries. According to an aspect, the power supply 870 further includes an external power source, such as an AC adapter or a powered docking cradle that supplements or recharges the batteries.

According to an aspect, the system 802 includes a radio 872 that performs the function of transmitting and receiving radio frequency communications. The radio 872 facilitates wireless connectivity between the system 802 and the “outside world,” via a communications carrier or service provider. Transmissions to and from the radio 872 are conducted under control of the operating system 864. In other words, communications received by the radio 872 may be disseminated to the application programs 850 via the operating system 864, and vice versa.

According to an aspect, the visual indicator 820 is used to provide visual notifications and/or an audio interface 874 is used for producing audible notifications via the audio transducer 825. In the illustrated example, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. According to an aspect, the system 802 further includes a video interface 876 that enables an operation of an on-board camera 830 to record still images, video stream, and the like.

According to an aspect, a mobile computing device 800 implementing the system 802 has additional features or functionality. For example, the mobile computing device 800 includes additional data storage devices (removable and/or non-removable) such as, magnetic disks, optical disks, or tape. Such additional storage is illustrated in FIG. 8B by the non-volatile storage area 868.

According to an aspect, data/information generated or captured by the mobile computing device 800 and stored via the system 802 are stored locally on the mobile computing device 800, as described above. According to another aspect, the data are stored on any number of storage media that are accessible by the device via the radio 872 or via a wired connection between the mobile computing device 800 and a separate computing device associated with the mobile computing device 800, for example, a server computer in a distributed computing network, such as the Internet. As should be appreciated such data/information are accessible via the mobile computing device 800 via the radio 872 or via a distributed computing network. Similarly, according to an aspect, such data/information are readily transferred between computing devices for storage and use according to well-known data/information transfer and storage means, including electronic mail and collaborative data/information sharing systems.

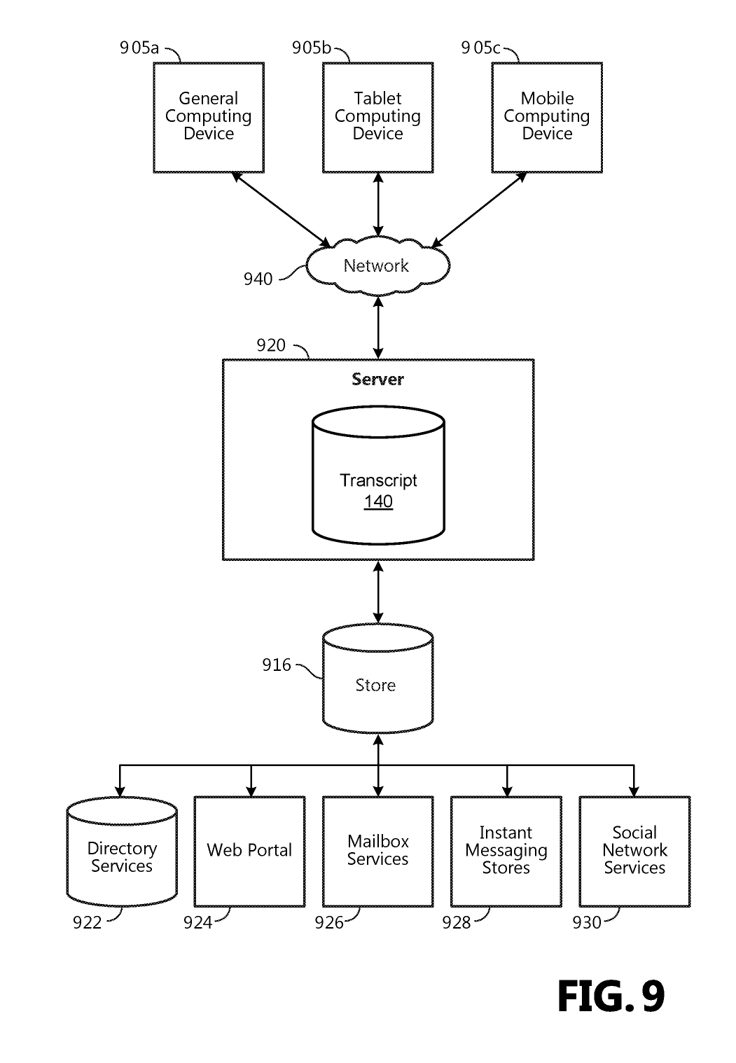

FIG. 9 illustrates one example of the architecture of a system for real-time caption correction by audience members as described above. Content developed, interacted with, or edited in association with the audience devices 150 and aggregation engine 160, such as the transcripts stored in the transcript database 140, is enabled to be stored in different communication channels or other storage types. For example, various documents may be stored using a directory service 922, a web portal 924, a mailbox service 926, an instant messaging store 928, or a social networking site 930. The audience devices 150 and aggregation engine 160 are operative to use any of these types of systems or the like for real-time caption correction, as described herein. According to an aspect, a server 920 provides the transcripts modified by the aggregation engine 160 to clients 905a,b,c. As one example, the server 920 is a web server providing the transcripts over the web. The server 920 provides the transcript over the web to clients 905 through a network 940 and the transcript may be integrated into an audiovisual data item as captions or as an independent document. By way of example, the client computing device is implemented and embodied in a personal computer 905a, a tablet computing device 905b or a mobile computing device 905c (e.g., a smart phone), or other computing device. Any of these examples of the client computing device are operable to obtain content from the store 916.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A method, comprising:
receiving audiovisual data;
recognizing speech data in the audiovisual data;
populating a transcript with textual data based on the speech data;
providing an editor interface, including the textual data, to an audience device;
receiving a selection from the editor interface of a text item from the textual data;
providing a replacement interface in the editor interface in association with the text item, the replacement interface including a suggested text item;
receiving a choice within the replacement interface of the suggested text item;
aggregating selections of the suggested text item;
determining whether the selections of the suggested text item satisfy an audience threshold; and
in response to the selections satisfying the audience threshold, updating the textual data with the suggested text item.

2. The method of claim 1, wherein the textual data are integrated with the audiovisual data as captioning in real-time with the audiovisual data.

3. The method of claim 1, further comprising:
in response to updating the textual data with the suggested text item, retransmitting the textual data to the audience device.

4. The method of claim 1, wherein the transcript is populated according to a contextual dictionary, the contextual dictionary configured to include words parsed from supplemental information discovered from a graph database based on contextual information parsed from the audiovisual data and to provide words matched to phonemes according to confidence scores based on:
an exactness of spoken phonemes from the speech data compared to stored phonemes associated with the words;
a frequency of use of the words; and
pronunciation feedback.

5. The method of claim 4, further comprising:
in response to the selections satisfying the audience threshold, updating the confidence scores for a given word in the personalized dictionary relative to other words in the personalized dictionary, wherein the given word is the suggested text item.

6. The method of claim 1, the replacement interface includes a custom entry control configured to accept text input to define one or more of a user-defined suggested text item and an updated suggested text item based on the text input.

7. The method of claim 1, wherein the replacement interface displays multiple suggested text items, wherein the multiple suggested text items are the n-best replacements for the selected text item according to confidence scores for populating the transcript.

8. The method of claim 1, wherein the text item includes multiple words selected from the textual data.

9. The method of claim 1, wherein the editor interface provides an enriching interface configured to apply richtext effects to the transcript, the richtext effects including:
font effects;
text colors;
typefaces; and
font sizes.

10. The method of claim 1, wherein the audiovisual data is live.

11. A system, comprising:
a processor; and
a memory storage device including instructions that when executed by the processor are operable to provide a replacement interface in response to a selection of a text item in a transcript, the replacement interface including:
one or more suggested text items wherein the one or more suggested text items are configured for selection by a user to replace the text item in the transcript, wherein the one or more suggested text items are chosen from a contextual dictionary for inclusion in the replacement interface based confidences scores, the confidence scores based on:
an exactness of phonemes representing the suggested text items compared to speech data from which the text item was generated;
a frequency of use of the suggested text items in a given language;
pronunciation feedback; and
a custom entry control, configured to accept text input to define one or more of a user-defined suggested text item and one or more updated suggested text items based on the text input, wherein the one or more updated suggested text items are chosen from the dictionary for inclusion in the replacement interface based confidences scores and the text input.

12. The system of claim 11, wherein the replacement interface is further configured to communicate a selection of a given suggested text item to an aggregation engine in communication with the contextual dictionary to increase a given confidence score associated with the given suggested text item.

13. The system of claim 11, wherein the transcript is presented as captioning for a live audiovisual content item, wherein the transcript is presented on and removed from a display device in concert with playback of the audiovisual content item in real-time, and wherein the captioning is selectable as the text item while the captioning is presented on the display device.

14. The system of claim 13, wherein the replacement interface is displayed in association with the text item selected from the captioning presented on the display device; and the replacement interface remains displayed on the display device after the captioning including the text item selected is removed from presentation on the display device.

15. The system of claim 14, wherein the replacement interface is removed from presentation on the display device in response to receiving a selection of a given suggested text item or in response to returning focus to the audiovisual content item.

16. The system of claim 11, wherein the text input filters the one or more updated suggested text items chosen from the dictionary based on the one or more updated suggested text items starting with characters comprising the text input.

17. A computer readable storage device, including instructions executable by a processor, comprising:
receiving live audiovisual data;
recognizing speech data in the live audiovisual data;
populating a transcript with textual data in real-time based on phonemes of the speech data matching words in a dictionary associated with the live audiovisual data;
providing an editor interface, including the textual data displayed in concert with the live audiovisual data, to an active audience device;
receiving a selection from the editor interface of a text item from the textual data;
providing a replacement interface in the editor interface in association with the text item, the replacement interface including a suggested text item chosen from the dictionary associated with the live audiovisual data;
receiving a selection within the replacement interface of the suggested text item;
aggregating selections of the suggested text item;
determining whether the selections of the suggested text item satisfy an audience threshold; and
in response to the selections satisfying the audience threshold, updating the textual data with the suggested text item.

18. The computer readable storage device of claim 17, wherein the audience threshold specifies a number of audience devices from which the suggested text item is to be aggregated from before updating the textual data with the suggested text item.

19. The computer readable storage device of claim 17, wherein the audience threshold specifies a confidence score that the suggested text item must satisfy, wherein the confidence score is based on how closely the suggested text item matches phonemes from which the text item was generated.

20. The computer readable storage device of claim 17, wherein the audience threshold is satisfied in response to detecting a trend in a series of corrections, wherein trends identify one or more of:
speech impediments;
accents;
non-standard pronunciations; and
spelling conventions.
